(19) United States
(12) Patent Application Publication
(10) Pub. No.: US 2006/0147716 A1
(43) Pub. Date: Jul. 6, 2006

(54) Elastic films with reduced roll blocking capability, methods of making same, and limited use or disposable product applications incorporating same

(76) Inventors: Jaime Braverman, Atlanta, GA (US); Bryon Paul Day, Canton, GA (US); Arthur E. Garavaglia, Alpharetta, GA (US); Holly A. Kiper, Canton, GA (US); Melpo Lambidonis, Cumming, GA (US); Tamara Lee Mace, Marietta, GA (US); Ann L. McCormack, Cumming, GA (US); Braulio Polanco, Roswell, GA (US); Prasad Shrikrishna Potnis, Duluth, GA (US); James A. Riggs, East Point, GA (US); Oomman Painummoottil Thomas, Alpharetta, GA (US)

Correspondence Address: KIMBERLY-CLARK WORLDWIDE, INC., 401 NORTH LAKE STREET, NEENAH, WI, 54956, US

(21) Appl. No.: 11/027,132

(22) Filed: Dec. 30, 2004

(51) Int. Cl. B32B 27/08; B32B 27/32

(52) U.S. Cl. 428/411.1; 428/521; 428/516; 156/244.11; 264/173.19; 264/174.11

(57) ABSTRACT

A thermoplastic elastomer film demonstrates reduced roll blocking capabilities. The film can either be breathable or nonbreathable. The breathable elastic film includes a core layer of a thermoplastic elastomer and a filled semi crystalline predominantly linear polymer and at least one skin layer of a polyethylene or filled polyethylene. The film core layer includes between about 25 and 70 weight percent filler, between about 5 and 30 by weight percent semi-crystalline linear polymer, and between about 15 and 60 by weight elastomer. The nonbreathable film desirable includes a core of 80-98 percent film volume and a skin of 20-2 percent film volume, with the core including both styrenic block copolymers and single site catalyzed polyethylenes and the skin including single site catalyzed polyethylenes and additional amounts of roll blocking prevention agents (antiblock agents).

### FIELD OF THE INVENTION

The present invention relates to elastic films and laminates made therefrom, manufacturing methods for making such films, and disposable product applications of such films.

### BACKGROUND OF THE INVENTION

Film and film/nonwoven laminates are used in a wide variety of applications, not the least of which is as elastic ear attachments, waistbands, side panels, leg gasketing and outercovers/backsheets for limited use or disposable products including personal care absorbent articles such as diapers, training pants, swimwear, incontinence garments, feminine hygiene products, mortuary products, wound dressings, bandages and the like. Film/nonwoven laminates also have applications in the protective cover area, such as car, boat or other object cover components, tents (outdoor recreational covers), agricultural fabrics (row covers) and in the veterinary and health care area in conjunction with such products as surgical drapes, hospital gowns and fenestration reinforcements. Additionally, such materials have applications in other apparel for clean room and health care settings.

In the personal care area in particular, there has been an emphasis on the development of film laminates which have good barrier properties, especially with respect to liquids, as well as good aesthetic and tactile properties such as hand and feel. There has been a further emphasis on the “stretch” comfort of such laminates, that is, the ability of the laminates to “give” as a result of the product utilizing such laminates being elongated in use, but also to provide a necessary level of recovery after being stretched, and vapor permeability in some product applications to maintain the skin health of a product user.

It is known that breathable inelastic polymeric films may be made by utilizing a variety of thermoplastic polymers in combinations with filler particles. These and other desired components, such as additives can be mixed together, heated and then extruded into a monolayer or multilayer filled film. Examples are described in WO96/19346 to McCormack et al. which is incorporated by reference hereto in its entirety. The filled film may be made by any one of a variety of film forming processes known in the art such as, for example, by using either cast or blown film equipment. The thermoplastic film can then be stretched either alone or as part of a laminate to impart breathability, opacity or other desired properties. The films are often stretched in a machine direction orienter-type apparatus, or other stretching device, which stretches the film, thereby creating a pore-like matrix in the film body at the locations of the filler particles. While such breathable films and film/ laminates are known to be used as personal care outercover materials, thereby allowing the personal care products to “breathe” and making such products more comfortable to wear, there has been difficulty producing such materials from “elastic”—type materials. Often, such breathable films are produced from polyolefin-based materials that can be extended without the ability to retract. While such film materials offer the comfort of air/gas circulation, and may offer the ability to extend only, they may limit or restrict movement of a user wearing articles made from such materials. If they are extended to a great extent, they may sag within the product, since they lack the ability to retract, and may in some circumstances, contribute to leakage. Such sagging sacrifices both the aesthetic appearance and the comfort level of the product.

It is has been found that if filler is placed in elastic polymer film formulations, the pores that are formed around the filler particles during a film formation stretch operation (such as in a machine direction orienter) are temporary, and close after stretching, as a result of the elastic attributes of the polymer component in the film. Without the pore structures, the film becomes non-breathable. It therefore is widely recognized that properties relating to elasticity and breathability are often conflicting. As a result of these attributes of highly elastic polymers, when breathable and elastic film materials have been sought for personal care product applications, manufacturers have often turned to inherently breathable elastic materials, that allow gasses to pass or diffuse through their structures, without the necessity for pores (which risk collapse). Such inherently breathable films may be more costly than other material films, often do not provide the level of breathability desired for consumer product applications, and often have to be fairly thin in order to achieve an acceptable level of breathability. Such thin films often lack the requisite strength/tear strength characteristics desired in personal care products.

Recently, filled breathable elastic films of varying basis weights have been created from noninherently breathable polymers, such as styrenic block copolymers, by utilizing specific manufacturing techniques and polymer combinations. The pores of such films do not collapse and the produced breathable elastic films may be efficiently laminated to nonwoven sheet structures without sacrificing elastic functionality. Such films are described in U.S. Ser. No. 10/703,761 titled Microporous Breathable Elastic Films, Methods of Making Same, and Limited Use or Disposable Product Applications, filed Nov. 7, 2003 which is incorporated by reference herein in its entirety.

Typically, film and film laminate materials that are used in personal care product applications are manufactured in one of two ways. In a first process, such film materials are manufactured in-line, that is, as part of a larger integrated laminate or end-product manufacturing process, where at least some of the product components are manufactured in a continuous process at the same physical location which allows them to be integrated into the larger product. Films made in the in-line process (either cast or blown) are immediately moved from a film forming station to further processing stations. In an in-line process there is no concern over film storage or transport conditions since there is little to no idle time between film formation and film usage/integration.

In the second type of film manufacturing process, films are formed and then rolled/wound for storage. This process is used either when the film forming station is in a different location from the other product processing stations, or alternatively when excess film is produced that is not needed immediately. With this process, the film is placed on a roll and stored for several days or even months. Such film rolls may be stored under less than ideal conditions, that is, in facilities without climate or humidity control. In such storage facilities, the stored films may encounter vast fluctuations in temperature. Such film rolls may have to be transported to alternate processing facilities, quite a distance from the original film production facility. Such films may also have to be further processed at various locations prior to being incorporated into a laminate or end product.

It has been found that stored films, and in particular stored elastic films such as those previously described, tend to roll block during storage. That is, such films tend to stick to themselves when placed under the normal storage pressure of a roll and also when stored in changing or even constant temperature and humidity conditions. Such sticking (roll blocking) renders the film roll unusable, since it cannot be unwound easily, or ruptures during an unwind operation, ultimately leading to material waste and higher processing costs. Even films that provide high breathability and stretch will be rendered useless if stored under less than ideal conditions. It would therefore be desirable to develop an elastic film that can be easily stored and transported under a variety of environmental conditions, and that can be easily unwound at a later date following film formation.

While printing of films is generally known in the art, it has been found that printing of elastic films poses manufacturing challenges. Often the elastic polymer in the film creates a film surface which makes it difficult to hold a clear printed image. It would therefore be desirable to create an elastic film that can be easily rolled upon itself for storage purposes, and that could be receptive to easily receiving printed images (such as those that might be created by an ink jet printer).

While multiple layered films are known in the art, it has been found that specific skin layers of films that may have been used in the past with films, do not assist in reducing roll blocking. In particular, layers that have been heretofore used for roll blocking or other processing advantages have proven inadequate for reducing roll blocking on breathable elastic films. It would therefore be desirable to produce breathable elastic films which are capable of storage, which do not suffer significant, if any reductions in elastic performance as a result of including multiple layers, and which may be successfully printed without loss of image clarity.

### SUMMARY OF THE INVENTION

A nonblocking elastic film of the invention demonstrates a tack level upon being unwound from a storage roll of less than about 20 g. In an-alternative embodiment, the nonblocking elastic film demonstrates a tack level upon being unwound from a storage roll of less than about 15 g. In still a further alternative embodiment of the invention, the nonblocking elastic film demonstrates a tack level of less than about 5 g. In yet another alternative embodiment of the invention, the nonblocking elastic film is a multilayered film including at least one skin layer and a core layer. In yet another alternative embodiment of the invention, the nonblocking elastic film is a multilayered film that is breathable. In yet another alternative embodiment of the invention, the nonblocking elastic film is a multilayered film including a core layer and at least one skin layer, wherein the core layer volume is between about 80 and 99 percent, and the skin layer(s) total volume is between about 1 and 20 percent. In yet another alternative embodiment, the core layer volume is between about 80 and 98 percent and the skin layer volume is between about 2 and 20 percent. In yet another alternative embodiment, the core layer volume is between about 80 and 97 percent and the skin layer volume is between about 3 and 20 percent. In yet another alternative embodiment of the invention, the nonblocking elastic film is breathable and demonstrates a WVTR of greater than about 100 g/m²/24 hours. In still another alternative embodiment, the nonblocking elastic film is breathable and demonstrates a WVTR of greater than about 1000 g/m²/24 hours.

In still a further alternative embodiment, the nonblocking elastic film includes at least one skin layer which skin layer includes a polyethylene having a density of between about 0.915 and 0.923 g/cc. In yet another alternative embodiment, the at least one skin layer further includes filler. In still a further alternative embodiment, filler is present in the skin layer(s) in an amount between about 5 and 50 weight percent of the skin layer.

In a further alternative embodiment of the invention, the nonblocking elastic film skin layer(s) comprise between about 1 and 4 volume percent of the film, and the core layer comprises between about 96 and 99 volume percent of said film. In still a further alternative embodiment of the invention the core layer includes a blended thermoplastic elastomer and a filled semi-crystalline predominantly linear polymer, with the core layer including between about 25 and 70 weight percent filler, between about 5 and 30 by weight percent semi-crystalline linear polymer, and between about 15 and 60 by weight elastomeric polymer. In such an embodiment, the filler is closely associated with the semi crystalline linear polymer, and the skin layer(s) comprise a low density polyethylene, and a filler.

In still a further alternative embodiment, the film is nonbreathable, and the core layer is comprised of a polyolefin based elastomer. In still a further alternative embodiment, the nonbreathable film is made from an elastic core and the skin layer(s) are comprised of between about 75 and 100 percent polyolefin based elastomeric material and between about 0 and 25 percent of a compound with at least 5 percent of an antiblock agent. In still a further alternative embodiment, the core layer comprises between about 95 and 97 percent of the volume of the film.

In yet another alternative embodiment, the nonblocking elastic film includes a core layer of a blend of between about 50/50 to 80/20 of a polyolefin based elastomer and a styrene block copolymer. In yet still another alternative embodiment, a nonblocking, breathable, multilayered elastic film includes a core layer and at least one skin layer, wherein the core layer comprises a blended thermoplastic elastomer and a filled semi-crystalline predominantly linear polymer, such that the core layer comprises between about 25 and 70 weight percent filler, between about 5 and 30 by weight percent semi-crystalline linear polymer, and between about 15 and 60 by weight elastomeric polymer, wherein the filler is closely associated with the semi crystalline linear polymer. In such embodiment, the skin layer includes a low density polyethylene having a density between about 0.915 and 0.923 g/cc, and a filler in a percentage of the skin layer of between about 5 and 50 weight percent. In yet another alternative embodiment, a nonblocking, nonbreathable multilayered elastic film includes a core layer and at least one skin layer, wherein the core layer is comprised of a polyolefin based elastomer, the skin layer is comprised of between about 75 and 100 percent polyolefin based elastomeric material, and between about 0 and 25 percent of a compound (including a resin) with at least 5 percent of an antiblock agent. In an alternative embodiment, the compound is present in the skin layer(s) in an amount of between about 0 and 15 weight percent, still alternatively between about 0 and 12 weight percent. In still a further alternative embodiment, the compound is between about 8 and 15 percent of the skin layer. In still a further alternative embodiment, the antiblock agent is between about 10 and 25 weight percent of the compound.

In still a further alternative embodiment, the compound includes up to 20 percent of an antiblock agent. In an alternative embodiment of the invention, the antiblock agent is present in the skin layer at between about 1 and 4 weight percent. In still a further alternative embodiment, the antiblock agent is present in the skin layer at between about 2 and 3 weight percent. Such previously described films may be used as a component in a personal care article, for example as an outercover of a personal care article, or an ear attachment substrate.

A method for producing a multilayered elastic film with reduced roll blocking includes coextruding a core layer and at least two skin layers on opposing surfaces of the core layer; wherein the core layer comprises a blended thermoplastic elastomer and a filled semi-crystalline predominantly linear polymer, such that the core layer comprises between about 25 and 70 weight percent filler, between about 5 and 30 by weight percent semi-crystalline linear polymer, and between about 15 and 60 by weight percent elastomeric polymer, wherein the filler is closely associated with said semi crystalline linear polymer. The skin layers comprise a low density polyethylene having a density between about 0.915 and 0.923 9/cc, and a filler in a percentage of the skin layers of between about 5 and 50 weight percent. The method also includes the steps of stretching the coextruded film in at least one direction; annealing the coextruded film; and allowing the coextruded film to retract between about 15 and 25 percent. In an alternative embodiment of the method, the method further includes the step of laminating a nonwoven layer to at least one side of the retracted coextruded film.

In an alternative embodiment, a method for producing a multilayered elastic film with reduced roll blocking includes the steps of coextruding a core layer and at least one skin layer, wherein the core layer is comprised of a polyolefin based elastomer, and the skin layer is comprised of between about 75 and 100 percent polyolefin based elastomeric material, and a compound having at least 5 percent of an antiblock agent. In an alternative embodiment, the method further includes the step of laminating a nonwoven layer to at least one side of the coextruded film. In still another alternative embodiment of the method, the method produces a film that demonstrates a load at 50 percent of between about 50 and 300 gf. In yet another alternative embodiment of the method, the method produces a film that demonstrates a load at 50 percent of at least 95 gf. Finally, in an alternate embodiment, a storage roll with elastomeric film stored thereupon demonstrates a tack level of less than 20 g upon said film being unwound from said roll.

### BRIEF DESCRIPTION OF THE DRAWINGS

The invention will be better understood by reference to the following description of embodiments of the invention taken in conjunction with the accompanying drawings, wherein:

FIG. 1 is a cross-sectional view of a film made in accordance with the invention.

FIG. 1A is a cross-sectional view of an alternate embodiment of a film made in accordance with the invention.

FIG. 1B is a cross-sectional view of another alternate embodiment of a film made in accordance with the invention.

FIG. 1C is a cross-sectional view of a film/laminate made in accordance with the invention.

FIG. 2 is a cross-sectional view of another film/laminate made in accordance with the invention.

FIG. 3 is a schematic of a process used to make a film and laminate in accordance with the invention.

FIG. 4 is a drawing of a diaper made in accordance with the invention.

FIG. 5 is a drawing of a training pant made in accordance with the invention.

FIG. 6 is a drawing of an absorbent underpant made in accordance with the invention

FIG. 7 is a drawing of a feminine hygiene product made in accordance with the invention.

FIG. 8 is a drawing of an adult incontinence product made in accordance with the invention.

### DETAILED DESCRIPTION OF THE INVENTION

Definitions:

As used herein, the term “personal care product” means diapers, training pants, swimwear, absorbent underpants, adult incontinence products, and feminine hygiene products, such as feminine care pads, napkins and pantiliners, as well as mortuary products.

As used herein the term “protective outer wear” means garments used for protection in the medical, veterinary or professional workplace, such as surgical gowns, hospital gowns, masks, and protective coveralls.

As used herein, the term “protective cover” means covers that are used to protect objects such as for example car, boat and barbeque grill covers, as well as agricultural fabrics.

As used herein the terms “polymer” and “polymeric” generally include but are not limited to, homopolymers, copolymers, such as for example, block, graft, random and alternating copolymers, terpolymers, etc. and blends and modifications thereof. Furthermore, unless otherwise specifically limited, the term “polymer” includes all possible spatial configurations of the molecule. These configurations include, but are not limited to isotactic, syndiotactic and random symmetries.

As used herein, the terms “machine direction” or MD means the length of a fabric or other web sheet in the direction in which it is produced. The terms “cross machine direction,” “cross directional,” “cross-direction”, or CD mean the width of fabric, i.e. a direction generally perpendicular to the MD.

As used herein, the term “nonwoven web” means a polymeric web having a structure of individual fibers or threads which are interlaid, but not in an identifiable, repeating manner. Nonwoven webs have been, in the past, formed by a variety of processes such as, for example, meltblowing processes, spunbonding processes, hydroentangling, air-laid and bonded carded web processes.

As used herein, the term “bonded carded webs” refers to webs that are made from staple fibers which are usually purchased in bales. The bales are placed in a fiberizing unit/picker which opens the bale from the compact state and separates the fibers. Next, the fibers are sent through a combining or carding unit which further breaks apart and aligns the staple fibers in the machine direction so as to form an essentially machine direction-oriented fibrous non-woven web. Once the web has been formed, it is then bonded by one or more of several bonding methods. One bonding method is powder bonding wherein a powdered adhesive is distributed throughout the web and then activated, usually by heating the web and adhesive with hot air. Another bonding method is pattern bonding wherein heated calendar rolls or ultrasonic bonding equipment is used to bond the fibers together, usually in a localized bond pattern through the web and/ or alternatively the web may be bonded across its entire surface if so desired. When using bicomponent staple fibers, through-air bonding equipment is, for many applications, especially advantageous.

As used herein the term “spunbond” refers to small diameter fibers which are formed by extruding molten thermoplastic material as filaments from a plurality of fine, usually circular capillaries of a spinneret with the diameter of the extruded filaments being rapidly reduced as by for example in U.S. Pat. No. 4,340,563 to Appel et al., and U.S. Pat. No. 3,692,618 to Dorschner et al., U.S. Pat. No. 3,802,817 to Matsuki et al., U.S. Pat. Nos. 3,338,992 and 3,341,394 to Kinney, and U.S. Pat. No. 3,542,615 to Dobo et al., which are each incorporated by reference in their entirety herein.

As used herein the term “meltblown” means fibers formed by extruding a molten thermoplastic material through a plurality of fine, usually circular die capillaries as molten threads or filaments into converging high velocity gas (e.g. air) streams which attenuate the filaments of molten thermoplastic material to reduce their diameter, which may be to microfiber diameter. Thereafter, the meltblown fibers are carried by the high velocity gas stream and are deposited on a collecting surface to form a web of randomly dispersed meltblown fibers. Such a process is disclosed, in various patents and publications, including NRL Report 4364, “Manufacture of Super-Fine Organic Fibers” by B. A. Wendt, E. L. Boone and D. D. Fluharty; NRL Report 5265, ” An Improved Device For The Formation of Super-Fine Thermoplastic Fibers” by K. D. Lawrence, R. T. Lukas, J. A. Young; and U.S. Pat. No. 3,849,241, issued Nov. 19, 1974, to Butin, et al., the patent being incorporated by reference hereto in its entirety.

As used herein the term “sheet” or “sheet material” refers to woven materials, nonwoven webs, polymeric films, polymeric scrim-like materials, and polymeric foam sheeting.

The basis weight of nonwoven fabrics is usually expressed in ounces of material per square yard (osy) or grams per square meter (g/m² or gsm) and the fiber diameters are usually expressed in microns. (Note that to convert from osy to gsm, multiply osy by 33.91). Film thicknesses may also be expressed in microns.

As used herein the term “laminate” refers to a composite structure of two or more sheet material layers that have been adhered through a bonding step, such as through adhesive bonding, thermal bonding, point bonding, pressure bonding, extrusion coating or ultrasonic bonding.

As used herein, the term “elastomeric” shall be interchangeable with the term “elastic” and refers to sheet material which, upon application of a stretching force, is stretchable in at least one direction (such as the CD direction), and which upon release of the stretching force contracts/returns to approximately its original dimension. For example, a stretched material having a stretched length which is at least 50 percent greater than its relaxed unstretched length, and which will recover to within at least 50 percent of the amount stretched from its original dimension (the elongation), upon release of the stretching force. A hypothetical example would be a one (1) inch sample of a material which is stretchable to at least 1.50 inches and which, upon release of the stretching force, will recover to a length of not more than 1.25 inches. Desirably, such elastomeric sheet contracts or recovers up to 50 percent of the amount stretched (from the original dimension) in the cross machine direction using a cycle test as described herein to determine percent set. Even more desirably, such elastomeric sheet material recovers up to 80 percent of the amount stretched (from the original dimension) in the cross machine direction using a cycle test as described. Even more desirably, such elastomeric sheet material recovers greater than 80 percent of the amount stretched (from the original dimension) in the cross machine direction using a cycle test as described. Desirably, such elastomeric sheet is stretchable and recoverable in both the MD and CD directions. For the purposes of this application, values of load loss and other “elastomeric functionality testing” have been generally measured in the CD direction, unless otherwise noted. Unless otherwise noted, such test values have been measured at 50 percent elongation on a 70 percent total elongation cycle (as described further in the test method section).

As used herein, the term “elastomer” shall refer to a polymer which is elastomeric.

As used herein, the term “thermoplastic” shall refer to a polymer which is capable of being melt processed.

As used herein, the term “inelastic” or “nonelastic” refers to any material which does not fall within the definition of “elastic” above.

As used herein, the term “breathable” refers to a material which is permeable to water vapor. The water vapor transmission rate (WVTR) or moisture vapor transfer rate (MVTR) is measured in grams per square meter per 24 hours, and shall be considered equivalent indicators of breathability. The term “breathable” desirably refers to a material which is permeable to water vapor having a minimum WVTR (water vapor transmission rate) of desirably about 100 g/m²/24 hours. Even more desirably, such material demonstrates breathability greater than about 300 g/m²/24 hours. Still even more desirably, such material demonstrates breathability greater than about 1000 g/m²/24 hours.

The WVTR of a fabric, in one aspect, gives an indication of how comfortable a fabric would be to wear. WVTR is measured as indicated below. Often, personal care product applications of breathable barriers desirably have higher WVTRs and breathable barriers of the present invention can have WVTRs exceeding about 1,200 g/m²/24 hours, 1,500 g/m²/24 hours, 1,800 g/m²/24 hours or even exceeding 2,000 g/m²/24 hours.

As used herein, the term “multilayer laminate” means a laminate including a variety of different sheet materials. For instance, a multi-layered laminate may include some layers of spunbond and some meltblown such as a spunbond/meltblown/spunbond (SMS) laminate and others as disclosed in U.S. Pat. No. 4,041,203 to Brock et al., U.S. Pat. No. 5,169,706 to Collier, et al., U.S. Pat. No. 5,145,727 to Potts et al., U.S. Pat. No. 5,178,931 to Perkins et al., and U.S. Pat. No. 5,188,885 to Timmons et al., each incorporated by reference in its entirety. Such a laminate may be made by sequentially depositing onto a moving forming belt first a spunbond fabric layer, then a meltblown fabric layer and last another spunbond layer and then bonding the laminate. Alternatively, the fabric layers may be made individually, collected in rolls, and combined in a separate bonding step or steps. Multilayer laminates may also have various numbers of meltblown layers or multiple spunbond layers in many different configurations and may include other materials like films or coform materials, e.g. SMMS, SM and SFS.

As used herein, the term “coform” means a process in which at least one meltblown diehead is arranged near a chute through which other materials are added to the web while it is forming. Such other materials may be pulp, superabsorbent particles, cellulosic fibers or staple fibers, for example. Coform processes are shown in commonly assigned U.S. Pat. No. 4,818,464 to Lau and U.S. Pat. No. 4,100,324 to Anderson et al., each incorporated by reference in its entirety.

As used herein, the term “conjugate fibers” refers to fibers which have been formed from at least two polymers extruded from separate extruders but spun together to form one fiber. Conjugate fibers are also sometimes referred to as multicomponent or bicomponent fibers. The polymers are usually different from each other though conjugate fibers may be monocomponent fibers. The polymers are arranged in substantially constantly positioned distinct zones across the cross-section of the conjugate fibers and extend continuously along the length of the conjugate fibers. The configuration of such conjugate fiber may be, for example, a sheath/core arrangement wherein one polymer is surrounded by another or may be a side by side arrangement, a pie arrangement or an “islands-in-the-sea” arrangement. Conjugate fibers are taught in U.S. Pat. No. 5,108,820 to Kaneko et al., U.S. Pat. No. 4,795,668 to Krueger et al., and U.S. Pat. No. 5,336,552 to Strack et al. Conjugate fibers are also taught in U.S. Pat. No. 5,382,400 to Pike et al., and may be used to produce crimp in the fibers by using the differential rates of expansion and contraction of the two or more polymers. For two component fibers, the polymers may be present in varying desired ratios. The fibers may also have shapes such as those described in U.S. Pat. No. 5,277,976 to Hogle et al., U.S. Pat. No. 5,466,410 to Hills and U.S. Pat. Nos. 5,069,970 and 5,057,368 to Largman et al., which describe fibers with unconventional shapes.

As used herein the term “thermal point bonding” involves passing a fabric or web of fibers to be bonded between a heated calender roll and an anvil roll. The calender roll is usually, though not always, patterned in some way so that the entire fabric is not bonded across its entire surface, and the anvil roll is usually flat. As a result, various patterns for calender rolls have been developed for functional as well as aesthetic reasons. One example of a pattern has points and is the Hansen Pennings or “H&P” pattern with about a 30% bond area with about 200 bonds/square inch as taught in U.S. Pat. No. 3,855,046 to Hansen and Pennings, incorporated herein by reference in its entirety. The H&P pattern has square point or pin bonding areas wherein each pin has a side dimension of 0.038 inches (0.965 mm), a spacing of 0.070 inches (1.778 mm) between pins, and a depth of bonding of 0.023 inches (0.584 mm). The resulting pattern has a bonded area of about 29.5%. Another typical point bonding pattern is the expanded Hansen Pennings or “EHP” bond pattern which produces a 15% bond area with a square pin having a side dimension of 0.037 inches (0.94 mm), a pin spacing of 0.097 inches (2.464 mm) and a depth of 0.039 inches (0.991 mm). Another typical point bonding pattern designated “714” has square pin bonding areas wherein each pin has a side dimension of 0.023 inches, a spacing of 0.062 inches (1.575 mm) between pins, and a depth of bonding of 0.033 inches (0.838 mm). The resulting pattern has a bonded area of about 15%. Yet another common pattern is the C-Star pattern which has a bond area of about 16.9%. The C-Star pattern has a cross-directional bar or “corduroy” design interrupted by shooting stars. Other common patterns include a diamond pattern with repeating and slightly offset diamonds with about a 16% bond area and a wire weave pattern looking as the name suggests, e.g. like a window screen pattern having a bond area in the range of from about 15% to about 21% and about 302 bonds per square inch. Typically, the percent bonding area varies from around 10% to around 30% of the area of the fabric laminate web. As is well known in the art, the spot bonding holds the laminate layers together as well as imparts integrity to each individual layer by bonding filaments and/or fibers within each layer.

As used herein, the term “ultrasonic bonding” means a process performed, for example, by passing the fabric between a sonic horn and anvil roll as illustrated in U.S. Pat. No. 4,374,888 to Bornslaeger, incorporated by reference herein in its entirety.

As used herein, the term “adhesive bonding” means a bonding process which forms a bond by application of an adhesive. Such application of adhesive may be by various processes such as slot coating, spray coating and other topical applications. Further, such adhesive may be applied within a product component and then exposed to pressure such that contact of a second product component with the adhesive containing product component forms an adhesive bond between the two components.

As used herein and in the claims, the term “comprising” is inclusive or open-ended and does not exclude additional unrecited elements, compositional components, or method steps. Accordingly, such terms are intended to be synonymous with the words “has”, “have”, “having”, “includes”, “including”, and any derivatives of these words.

As used herein the terms “recover”, “recovery” and “recovered” shall be used interchangeably and shall refer to a contraction of a stretched material upon termination of a stretching force following stretching of the material by application of the stretching force. For example, if a material having a relaxed, unstretched length of 1 inch (2.5 cm) is elongated fifty percent by stretching to a length of 1.5 inches (3.75 cm), the material would be elongated 50 percent and would have a stretched length that is 150 percent of its relaxed length or stretched 1.5×. If this exemplary stretched material contracted, that is recovered to a length of 1.1 inches (2.75 cm) after release of the stretching force, the material would have recovered 80 percent of its 0.5 inch (1.25 cm) elongation. Percent recovery may be expressed as [(maximum stretch length-final sample length)/(maximum stretch length−initial sample length)]×100.

As used herein the term “extensible” means elongatable in at least one direction, but not necessarily recoverable.

As used herein the term “percent stretch” refers to the ratio determined by measuring the increase in the stretched dimension and dividing that value by the original dimension. i.e. (increase in stretched dimension/original dimension)×100.

As used herein the term “set” refers to retained elongation in a material sample following the elongation and recovery, i.e. after the material has been stretched and allowed to relax during a cycle test.

As used herein the term “percent set” is the measure of the amount of the material stretched from its original length after being cycled (the immediate deformation following the cycle test). The percent set is where the retraction curve of a cycle crosses the elongation axis. The remaining strain after the removal of the applied stress is measured as the percent set.

The “load loss” value is determined by first elongating a sample to a defined elongation in a particular direction (such as the CD) of a given percentage (such as 70 or 100 percent as indicated) and then allowing the sample to retract to an amount where the amount of resistance is zero. The cycle is repeated a second time and the load loss is calculated at a given elongation, such as at the 50 percent elongation. Unless otherwise indicated, the value was read at the 50% elongation level (on a 70 percent elongation test) and then used in the calculation. For the purposes of this application, the load loss was calculated as follows:

$$\frac{\begin{matrix}cycle 1 extension tension ( at 50 \% elongation ) - \\ cycle 2 retraction tension ( at 50 \% elongation )\end{matrix}}{cycle 1 extension tension ( at 50 \% elongation )} \times 100$$

This formula is particularly applicable to the breathable film testing described herein.

For the test results reflected in this application, the defined elongation was 70 percent unless otherwise noted. The actual test method for determining load loss values is described below.

As used herein, a “filler” is meant to include particulates and/or other forms of materials which can be added to a film polymer extrusion material which will not chemically interfere with or adversely affect the extruded film and further which are capable of being dispersed throughout the film. Generally the fillers will be in particulate form with average particle sizes in the range of about 0.1 to about 10 microns, desirably from about 0.1 to about 4 microns. As used herein, the term “particle size” describes the largest dimension or length of the filler particle.

As used herein the terms semi-crystalline, predominantly linear polymer and semi-crystalline polymer shall refer to polyethylene, polypropylene, blends of such polymers and copolymers of such polymers. For such polyethylene-based polymers, such term shall be defined to mean polymers having a melt index of greater than about 5 g/10 min, but desirably greater than 10 g/10 min (Condition E at 190° C., 2.16kg) and a density of greater than about 0.910 g/cc, but desirably greater than about 0.915 g/cc. In one embodiment, the density is between about 0.915 g/cc and 0.960 g/cc. In a further alternative embodiment, the density is about 0.917 g/cc. In a further alternative embodiment, the density is between about 0.917 g/cc and 0.960 g/cc. In still a further alternative embodiment, the density is between about 0.917 g/cc and 0.923 g/cc. In still a further alternative embodiment, the density is between about 0.923 g/cc and 0.960 g/cc. For such polypropylene based polymers, such term shall be defined to mean polymers having a melt flow rate greater than about 10 g/ 10 min, but desirably greater than about 20 g/10 min. (230° C., 2.16 kg) and having a density between about 0.89 g/cc and 0.90 g/cc.

As used herein, the term “antiblock agent” shall mean a substance, such as for example finely divided solid of a mineral nature, which is added to a polymer mix to prevent adhesion of the surfaces of films made from the polymer to each other or to other surfaces. An antiblock may be a filler such as for example, calcium carbonate or diatomaceous earth.

Unless otherwise indicated, percentages of components in formulations are by weight.

Test Method Procedures:

Basis Weight:

To determine basis weight, first cut and weigh a specimen with a known area of at least 20 square inches. Then calculate the basis weight as follows:
Area of specimen (in.²)=Length×Width

If the specimen area is unknown, determine the area of the specimen by measuring the length and width to the nearest 0.1 in. Then calculate using the following equation and factors.

| | |
|---|---|
| Calculation of basis weight: | [Weight(g)/Area] × Factor |
| Factors for basis weight: | g/m² = 1550 |
| | g/yd² = 1296 |
| | lb/2880 ft² = 914.31 |
| | oz/yd² = 45.72 |

If multiple plies are used to determine weight and basis weight per ply is desired, divide the weight by the total number of plies weighed before determining basis weight.

Water Vapor Transmission Rate (WVTR)/ Breathability:

A suitable technique for determining the WVTR (water vapor transmission rate) value of a film or laminate material of the invention is the test procedure standardized by INDA (Association of the Nonwoven Fabrics Industry), number IST-70.4-99, entitled “STANDARD TEST METHOD FOR WATER VAPOR TRANSMISSION RATE THROUGH NONWOVEN AND PLASTIC FILM USING A GUARD FILM AND VAPOR PRESSURE SENSOR” which is incorporated by reference herein. The INDA procedure provides for the determination of WVTR, the permeance of the film to water vapor and, for homogeneous materials, water vapor permeability coefficient.

The INDA test method is well known and will not be set forth in detail herein. However, the test procedure is summarized as follows. A dry chamber is separated from a wet chamber of known temperature and humidity by a permanent guard film and the sample material to be tested. The purpose of the guard film is to define a definite air gap and to quiet or still the air in the air gap while the air gap is characterized. The dry chamber, guard film, and the wet chamber make up a diffusion cell in which the test film is sealed. The sample holder is known as the Permatran-W Model 100K manufactured by Mocon, Inc., Minneapolis, Minn. A first test is made of the WVTR of the guard film and the air gap between an evaporator assembly that generates 100% relative humidity. Water vapor diffuses through the air gap and the guard film and then mixes with a dry gas flow which is proportional to water vapor concentration. The electrical signal is routed to a computer for processing. The computer calculates the transmission rate of the air gap and the guard film and stores the value for further use.

The transmission rate of the guard film and air gap is stored in the computer as CalC. The sample material is then sealed in the test cell. Again, water vapor diffuses through the air gap to the guard film and the test material and then mixes with a dry gas flow that sweeps the test material. Also, again, this mixture is carried to the vapor sensor. This information is used to calculate the transmission rate at which moisture is transmitted through the test material according to the equation:
TR⁻¹_{test material}=TR⁻¹_{test material, guardfilm, airgap}−TR⁻¹_{guardfilm, airgap}

Calculations:
WVTR: The calculation of the WVTR uses the formula:
   WVTR=Fρₛₐₜ(T)RH/(Apₛₐₜ(T)(1−RH))
   where:
F=The flow of water vapor in cc/min.,
ρₛₐₜ(T)=The density of water in saturated air at temperature T,
RH=The relative humidity at specified locations in the cell,
A=The cross sectional area of the cell, and,
ρₛₐₜ(T)=The saturation vapor pressure of water vapor at temperature T.

For the purposes of this Application, the testing temperature for the above test was at about 37.8° C., the flow was at 100 cc/min, and the relative humidity was at 60%. Additionally, the value for n was equal to 6 and the number of cycles was 3.

Cycle Testing

In the cycle test methods which are described below, it was appropriate to utilize larger physical samples for the breathable materials as opposed to the nonbreathable materials. This is the case, since the breathable materials are commonly used in outercover applications, whereas the nonbreathable materials are commonly used in smaller ear attachment areas.

Cycle Testing for Breathable Film

The materials were tested using a cyclical testing procedure to determine load loss and percent set. In particular, 2 cycle testing was utilized to 70 percent defined elongation. For this test, the sample size was 3 inch in the MD by 6 inch in the CD. The Grip size was 3 inch width. The grip separation was 4 inch. The samples were loaded such that the cross-direction of the sample was in the vertical direction. A preload of approximately 10-15 grams was set. The test pulled the sample at 20 inches/min (500 mm/min) to 70 percent elongation (2.8 inches in addition to the 4 inch gap), and then immediately (without pause) returned to the zero point (the 4 inch gauge separation). In-process testing (resulting in the data in this application) was done as a 2 cycle test. The results of the test data are all from the first and second cycles. The testing was done on a Sintech Corp. constant rate of extension tester 2/S with a Renew MTS mongoose box (controller) using TESTWORKS 4.07b software. (Sintech Corp, of Cary, N.C.). The tests were conducted under ambient conditions.

Elastic Testing for Nonbreathable Film examples:

Tension Set

Sample Size: 0.5 “(center)×7” (Dogbone)

Gage Length: 3 inches

Test Speed: 20 inches/minute

In this intermittent stress elongation test, a sample is stretched to a predetermined elongation, released and then stretched to the next greater degree of elongation and so on. The remaining % strain at a given time (% set) after the removal of the applied stress is then measured. The tension set gives a measure of the irreversibility of the deformation.

Specimen is clamped into the jaws of a Materials Testing System (MTS) Sintech 1/S testing frame. Via the cross head movement, the specimen is displaced at a rate of 20 inches per minute to 25% elongation and is then returned at the same speed to the original start position. This occurs again for elongations of 50%, 100%. The results of this test method gives the following data. Load @25% Elongation, % Set @25% Elongation, Load @50% Elongation, % Set @50% Elongation, Load @100% Elongation.

Equilibrium Hysteresis

Sample Size: 1″×7″ (film)

Gage Length: 3inches

Test Speed: 20 inches/minute

This cycle test determines energy loss from extending a specimen to 100% elongation and returning it to the initial start position. The test is repeated for 1-3 cycles. The specimen is clamped into the jaws of a Materials Testing System (MTS) Sintech 1/S testing frame. Via the cross head movement, the specimen is displaced at a rate of 20 inches per minute to 100% elongation and is then returned at the same speed to the original start position. Load response is measured at 25%, 50% and 100% elongation. This is repeated for a total of 1-3 cycles. The test method gives the following data: Extension Load @25, 50 and 100% Elongation (Cycles 1-3), Return Load @50% Elongation (Cycles 1-3), % Hysteresis (Cycles 1-3) . The pre-load is less than 25 g and testing was done at ambient conditions.

(Tensile) Stress Elongation

Sample Size: 1″×7″

Gage Length: 3 inches

Test Speed: 20 inches/minute

The specimen is clamped into the jaws of a Materials Testing System (MTS) Sintech 1/S testing frame. The specimen is displaced at a rate of 20 inches per minute via the cross head movement until the specimen breaks or test limits are reached. The test method gives the following data. Load @50% Elongation, Load @100% Elongation, % Elongation at Stop (2000 grams), Load @ Intercept, Load @ Break, % Elongation @ Break. The pre-load is less than 25 g and testing was done at ambient conditions.

The longer dimension is between the grips for the tests.

Peel Test for Film Blocking (T-Peel)

A 180 degree Peel Test (reference ASTM E 171-87) was utilized to simulate the ease or difficulty of peeling a sample film layer from a storage roll. The test procedure was modified in terms of the sample size. The test is designed to test film sticking between two film layers.

Sintech Set-Up Parameters:

Cross-head speed is 12 inches per minute (304.88 mm per minute)

Grip Design: 1 inch by 3 inch (25.4 mm by 76.2 mm)

Grip Pressure: 82 psi

Starting Gage Length: 6 inches (152.4 mm)

Clamping Tension: minimal required to eliminate wrinkles in material.

Test Procedure:

To conduct the test, about 20-25 layers of film were taken off from the center slit of the 200 yards on the roll of film. During this testing procedure, the plies of 3 inch (CD) by 7 inch (MD)(76.2 by 177.8 mm) specimens were manually separated for a distance of 2 inches (50.8 mm). This is the initial distance between the clamps. The machine direction length must be a minimum of 7 inches in length. No tape was used to reinforce the samples as may be done in the test when testing peels between a spunbond layer and film layer in the case of film/nonwoven laminates. One layer is then clamped into each jaw of the tensile tester (MTS 10/GL Sintech). The specimen is them subjected to a constant rate of tension at 12 inches per minute (304.88 mm per minute). The length of each tested area within the sample is 4 inches (101.6 mm). The final distance between the clamps at the end of the peel test is 6 inches. The average peel strength required to separate the component layers of the film is determined and recorded as the peel strength of the specimen. The load cell was 10 pounds.

Sample Preparation:

Non accelerated aging: Film material was manually cut off the roll in approximately 20-25 layer slabs. The film was then die cut to 3 inch (CD) by 7 inch (MD) (76.2 by 177.8 mm) specimens and separated into layers of two film layers, then tested as per the summary above.

Peels were also tested at 130° F. by placing the rolls of the control skinless film and films with skin layers in a Memnert, Model 700 Convection Oven for 48 hours. In this case, the films with the LDPE and the LDPE/CaCO3 skin layers present were not observed to demonstrate blocking. However, in the case of the control and the other skins layers, the film could not be peeled to be tested due to excessive blocking.

Coefficient of Friction (COF) Test

The COF test was conducted exactly as per the ASTM D 1894-87 and was measured against a metal surface. During the Coefficient of Friction testing, the metal surface used was polished metal 150 by 300 by 1 mm, and the sled used was a metal block 63.5 mm square, 6 mm thick, wrapped in 3.2 mm sponge rubber with a density of 0.25 g/cc.

Tack Test

In this test, tack was measured as the force required to release the film from the surface of a circular plastic foot after being subjected to a large load for a selected amount of time. The small surface area of the foot resulted in a very high force on the film and caused the temporary bond in the case of the films that were more prone to blocking.

This test was performed using the Texture Analyzer model TA-XT2i from Texture Technologies Corp., Scarsdale, N.Y. The Texture Analyzer setting version: 07.1.5H, load cell:5 was used. During the test, the Measure distance to compression mode was selected. The testing parameters used were: Pre-test speed 5.0 min/sec, distance 10.0 mm, test speed 5.0 mm/sec, force 3500 gms, post test speed 5.0 mm/sec, time 120 secs, rupture distance 1.0 mm. The plastic foot was 35 mm tall, 0.50 inch diameter, of 80 AC Acrylic cylinder, manufactured by Texture Technologies as Part # TA-10.

A film sample sized 14 cm by 14 cm was cut and placed on the test platform. A thick plate (10 cm×8.8 cm×1.1 cm) with a 38 mm hole in the center was placed on top of the sample and held in place with “C” clamps on its left and right side. Care was taken to eliminate all wrinkles on the film surface. The force to release the plastic foot from the film was measured from the force versus distance plot and correlated to the level of blocking in between the layers of the film samples. The tack force measured with this test for the samples is measured in grams. Typically the number of samples tested/repetitions was 5.

Melt Index or Melt Flow Rate

Melt Index (MI) or Melt Flow Rate (MFR) depending on the polymer being tested, is a measure of how easily a resin flows at a given temperature and shear rate, and can be determined using ASTM Standard D1238, condition 190° C./2.16 kg (Condition E) generally for polyethylene-based polymers. The melt index test data in this application were produced in accordance with this method and condition. In general, a polymer having a high melt index has a low viscosity. For polypropylene-based polymers, a similar analysis is conducted for melt flow rate at a condition of 230° C. and 2.16 kg. In accordance with the present invention the combination of melt index or melt flow rate (depending on polymer) and density parameters of the carrier resin results in the improved two phase film with increased ability for the carrier resin to aid in processing and to retain pore formation following stretching. In particular, it has been determined that non-elastic, more crystalline carrier resins with higher MI values (above about 5 g/10 min) and density values(between about 0.910 g/cc and 0.960 g/cc for polyethylene-based polymers) were particularly effective at producing the cores of multilayered breathable films without sacrificing elastic performance. In particular, carrier resins with densities greater than about 0.915 g/cc are desirable. Such carrier resins with densities of about 0.917 g/cc are also desirable. Such carrier resins with densities greater than about 0.917 g/cc are also desirable. In still a further embodiment, such carrier resins with densities between 0.917 g/cc and 0.960 g/cc are desirable. In still a further alternative embodiment, such carrier resins with densities between about 0.917 g/cc and 0.923 g/cc are also desirable. In still a further alternative embodiment, such carrier resins with densities between about 0.923 g/cc and 0.960 g/cc are also desirable. In an alternative embodiment, polypropylene—based carrier resins with lower densities such as about 0.89 g/cc, would also be useful, especially those with a MFR of greater than about 10 g/10 min, but desirably 20 g/10 min MFR or greater (conditions 230° C., 2.16 kg). In still a further alternative embodiment, such polypropylene-based carrier resins with densities between about 0.89 g/cc and 0.90 g/cc can also be utilized. It is also desirable to blend such carrier resins separately with a filler, prior to blending the carrier/filler mixture with the elastomer component of the core layer, so that all materials are not compounded together in a single step. It is desirable that the filler be maintained in close association with the carrier in the core rather than blending any filler directly with the elastomer component, such that the carrier resin forms filler rich pockets within the elastomer component of the core layer of a multilayered film.

### DESCRIPTION OF THE EMBODIMENTS

The problems surrounding the storage of elastic films on a roll may be reduced or eliminated by creating either a multiple layered structure for a breathable elastic film that demonstrates a particular tack level, or by formulating an elastic film (that is not breathable) in a particular manner that demonstrates the certain tack level. The films may then be stored on a roll prior to usage. The problems are addressed in a first embodiment of the invention by a multiple layered elastic and breathable filled film wherein the film core composition provides breathability and elasticity without pore collapse, and the skin layers have been designed to specifically produce enhanced resistance to roll blocking for storage purposes, without significantly interfering with elastic performance or breathability. The problems are addressed in the second embodiment of the invention by a polymer specific nonbreathable multilayered elastic film which reduces roll blocking. Further advantages, features, aspects and details of the invention are evident from the claims, the description and the accompanying drawings.

Breathable Non-Blocking Elastic Film

Two methods of formulating films for making breathable filled films are a concentrate letdown approach and a fully compounded approach. For the purposes of at least the breathable films of the current application, the concentrate letdown approach is desirable as described in U.S. Ser. No. 10/703,761 titled Microporous Breathable Elastic Films, Methods of Making Same, and Limited Use or Disposable product Applications, filed Nov. 7, 2003, which is hereby incorporated by reference in its entirety. It should be recognized however, that fully compounded approaches can also be utilized for one or more layers of a multilayered film.

In the concentrate letdown process, one resin is used as a carrier resin to make a concentrate with a filler. In one embodiment of the invention in the current application, the carrier resin, typically a high melt index or melt flow rate/low viscosity resin with higher density level for polyethylene-based polymers (0.910 g/cc-0.960 g/cc), and a density level between about 0.89 g/cc and 0.90 g/cc for polypropylene-based polymers, is used to disperse high loadings of filler. The elastic letdown resin dominates the elastic properties of the core layer of the multilayered film. The concentrate is let down (combined) with elastic resin to dilute the final filler content to a desired percentage in the core layer of the multilayered film.

The core of the elastic, filled breathable film is made from a thermoplastic elastomer let down resin, desirably a block copolymer (such as a styrenic block copolymer) that has been blended with a semi-crystalline, predominantly linear polymer (carrier resin) which includes a filler (the “concentrate”). Desirably, the elastic polymer is blended with a single screw extruder so as to avoid/reduce substantial mixing of the polymer phases, and retain pockets of the carrier resin within the letdown resin (in the core layer). The filler, such as calcium carbonate, creates filled regions within the extruded film core layer, that can be stretched to form pores at the semi-crystalline polymer/filler interface, without negatively impacting the elastic recovery of the non-filled elastic polymer component. It is theorized that the pores in the filled regions do not collapse as the formed pores are surrounded by an inelastic semi-crystalline polymer shell. As was stated previously, either higher density polyethylene-based carrier resins or polypropylene-based carrier resins with densities between 0.89 g/cc and 0.90 g/cc are preferred. Desirably, the filled carrier semi-crystalline polymer (filled polymer or concentrate) is compounded with the filler prior to combining with the thermoplastic elastomer let down resin to surround the filler particle only with the semi crystalline polymer, thus forming a predominantly non-elastic shell around the filler particles, capable of pore formation and retention when the film having this core composition is stretched.

One or more skin layers can be coextruded with the core layers to provide a multilayered elastic and breathable film with a nonblocking surface. In one embodiment of the nonblocking elastic breathable film, one or more skin layers includes a lower density polyethylene and a filler. In this way, the skin does not impact the film's breathability or elastic attributes. In an alternative embodiment of the multilayered film, one of the skin layers is a filled lower density polyethylene and the other is a nonfilled lower density polyethylene. Each of the skin layers is on opposite sides of the filled core layer. In one particular embodiment, the filler is calcium carbonate. In another embodiment, the one or more skin layers includes a lower density polyethylene and an additional nonblocking agent.

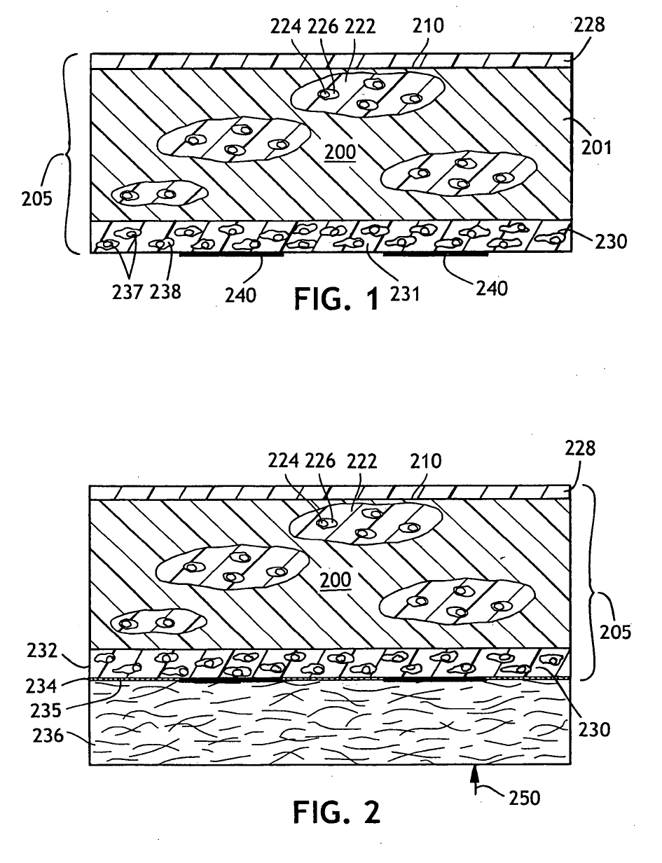

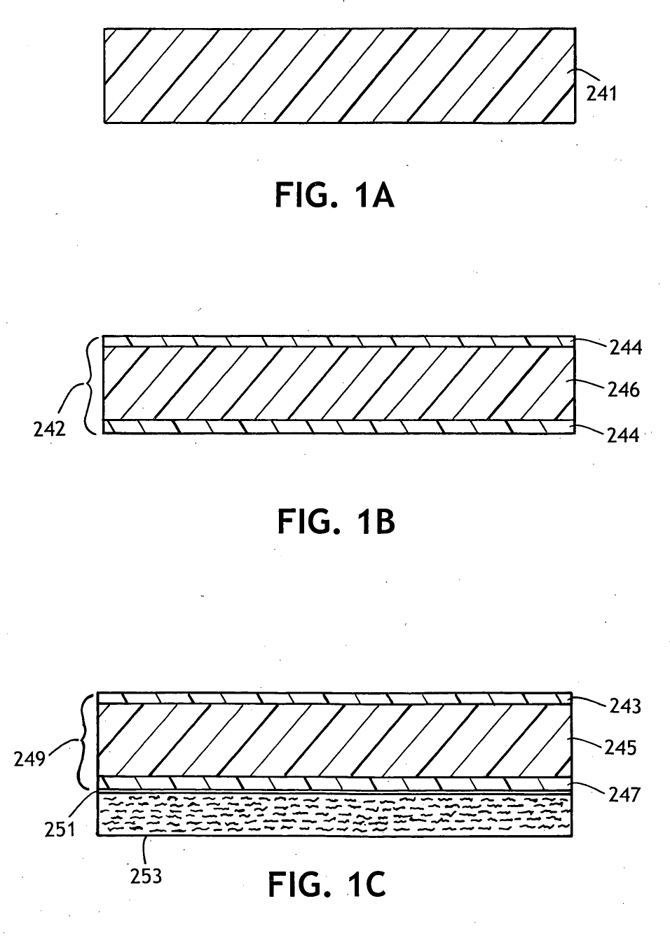

As can be seen in FIG. 1, which illustrates a cross sectional view of a multilayered film (film that has been stretched) made in accordance with the invention, the film 205 includes an elastomeric core layer 201 having an elastomeric component 200. Skin layers 228 and 230 are positioned on each opposing surface of the film core layer 201. While two skin layers are illustrated in FIG. 1 on opposing sides of the core layer, it should be appreciated that the film may include only one skin layer, such as skin layer 228, or more than two skin layers, such that more than one skin layer is present on at least one surface of the core layer 201. The skin layers may be formed of inherently breathable polymers or alternatively, polymers with filler if a breathable film is desired.

In the core layer 201, semi-crystalline polymer/filler rich pockets 222 are dispersed throughout the elastomeric component 200, desirably with the filler isolated to the carrier resin locations. Filler particles 224 are contained within the semi-crystalline polymer pockets 222 or pores. The pores are created by the hard shell/walls of the semi-crystalline polymer phase within the elastomeric polymer phase. The pores/spaces 226 are formed between the semi-crystalline polymers and the filler particles 224 as the film is stretched in a machine direction orienter or other stretching device. Since the shells are made of a semi-crystalline material, they retain much of their shape, albeit in a compressed or elongated oval-type shape when stretched uniaxially, rather than a perfectly circular configuration. The shells retain a more circular configuration when stretched biaxially. It should be recognized that the illustration of FIG. 1 is a stylized schematic image.

Various thermoplastic elastomers are contemplated for use in this invention as the core elastomeric portion. However, thermoplastic block polymers such as styrenic block copolymers are examples of useful elastic polymers of the invention. Specific examples of useful styrenic block copolymers include hydrogenated polyisoprene polymers such as styrene-ethylenepropylene-styrene (SEPS), styrene-ethylenepropylene-styrene-ethylenepropylene (SEPSEP), hydrogenated polybutadiene polymers such as styrene-ethylenebutylene-styrene (SEBS), styrene-ethylenebutylene-styrene-ethylenebutylene (SEBSEB), styrene-butadiene-styrene (SBS), styrene-isoprene-styrene (SIS), and hydrogenated poly-isoprene/butadiene polymer such as styrene-ethylene-ethylenepropylene-styrene (SEEPS). Polymer block configurations such as diblock, triblock, multiblock, star and radial are also contemplated in this invention. In some instances, higher molecular weight block copolymers may be desirable. Block copolymers are available from Kraton Polymers U.S. LLC of Houston, Tex. under the designations KRATON D or G polymers, for example G1652 and G1657 and Septon Company of America, Pasadena, Tex. under the designations SEPTON 2004, Septon 4030, and Septon 4033. Another potential supplier of such polymers includes Dynasol of Spain, and Dexco polymers of Houston, Tex. In particular, SEPTON 2004 SEPS triblock polymer is suitable for use as the core elastomeric portion in the invention. Blends of such elastomeric materials are also contemplated as the “elastomeric core component”. For instance, a blend of G1652 and G1657 may be utilized, such that an elastomeric component may be present in a final film core formulation at about 33% by weight, 10 percent (of the total film formula) of which is G1652 and 23 percent (of the total film formula) of which is G1657. Such an embodiment could include filler and concentrate as the remaining 67 percent by weight of the core component. In one embodiment, it is desirable that the styrenic block copolymer is a SEPS polymer. The thermoplastic elastomers themselves may include processing aids and/or tackifiers associated with the elastomeric polymers. Other thermoplastic elastomers useful in the invention include olefinic-based elastomers such as EP rubber, ethyl, propyl, butyl terpolymers, block and copolymers thereof. Other potential block copolymers include Dexco polymers under the designations VECTOR 4111, 8508, Dynasol polymers under the designations CALPRENE H-6110, 6120, 6140 and 6170, thermoplastic polyurethanes from Dow, Noveon and BASF, and thermoplastic ether esters from Dupont.

Desirably, the film core layer of the filler, carrier resin and elastomeric letdown resin materials includes between about 15 and 50 weight percent elastomeric polymer component. More desirably, the product film core of the blended materials includes between about 20 and 40 weight percent elastomer. It should be recognized, that when the elastomer component of the blended elastomeric composition is given, it may include neat base resins along with processing aids such as low molecular weight hydrocarbon materials such as waxes, amorphous polyolefins and/or tackifiers.

Both organic and inorganic fillers are contemplated for use with the present invention core layer, provided they do not interfere with the film forming process and/or subsequent laminating processes. Examples of fillers include calcium carbonate (CaCO₃), various clays, silica (SiO₂), alumina, barium sulfate, sodium carbonate, talc, magnesium sulfate, titanium dioxide, zeolites, aluminum sulfate, cellulose-type powders, diatomaceous earth, gypsum, magnesium sulfate, magnesium carbonate, barium carbonate, kaolin, mica, carbon, calcium oxide, magnesium oxide, aluminum hydroxide, pulp powder, wood powder, cellulose derivatives, polymeric particles, chitin and chitin derivatives.

The filler particles may optionally be coated with a fatty acid, such as stearic acid or behenic acid, and/or other material in order to facilitate the free flow of the particles (in bulk) and their ease of dispersion into the carrier polymer. One such filler is calcium carbonate sold under the brand SUPERCOAT, of Imerys of Roswell, Ga. Another is OMYACARB 2 SS T of Omya, Inc. North America of Proctor, Vt. The latter filler is coated with stearic acid. Desirably, the amount of filler in the product film core layer (final film formulation) is between about 40 and 70 weight percent. More desirably, the amount of filler in the product film core layer is between about 45 and 60 weight percent.

Examples of semi-crystalline carrier polymers useful in compounding with filler include, but are not limited to predominantly linear polyolefins (such as polypropylene and polyethylene) and copolymers thereof.

Such carrier materials are available from numerous sources. Specific examples of such semi-crystalline polymers include Dow polyethylenes such as DOWLEX™ 2517 (25 MI, 0.917 g/cc); Dow LLDPE DNDA-1082 (155 MI, 0.933 g/cc), Dow LLDPE DNDB-1077 (100 MI, 0.929 g/cc), Dow LLDPE 1081 (125 MI, 0.931 g/cc), and Dow LLDPE DNDA 7147 (50 MI, 0.926 g/cc). In some instances, higher density polymers may be useful, such as Dow HDPE DMDA-8980 (80 MI, 0.952 g/cc). Additional resins include ESCORENE LL 5100, having a MI of 20 and a density of 0.925 and ESCORENE LL 6201, having a MI of 50 and a density of 0.926 from ExxonMobil.

In an alternative embodiment, polypropylene carrier resins with lower densities such as at about 0.89 g/cc, would also be useful, especially those with a 10 g/10 min MFR, but desirably a 20 MFR or greater (conditions of 230° C., 2.16 kg). Polypropylene-based resins having a density of between 0.89 g/cc and 0.90 g/cc would be useful, such as homopolymers and random copolymers such as ExxonMobil PP3155 (36 MFR), PP1074KN (20 MFR), PP9074MED (24 MFR) and Dow 6D43 (35 MFR).

It is desirable that the melt index of the semi-crystalline polymer (for polyethylene-based polymers) be greater than about 5 g/10 min, as measured by ASTM D1238 (2.16kg, 190° C.). More desirably, the melt index of the semi-crystalline polymer is greater than about 10 g/10 min. Even more desirably, the melt index is greater than about 20 g/10 min. Desirably, the semi-crystalline carrier polymer has a density of greater than about 0.910 g/cc, but even more desirably greater than about 0.915 g/cc for polyethylene-based polymers. Even more desirably, the density is about 0.917 g/cc. In another alternative embodiment, the density is greater than 0.917 g/cc In still another alternative embodiment, the density is between about 0.917 g/cc and 0.923 g/cc. In still another alternative embodiment, the semi-crystalline carrier polymer has a density between about 0.917 and 0.960 g/cc. In yet another alternative embodiment, the semi-crystalline polymer has a density between about 0.923 g/cc and 0.960 g/cc. It is also desirable that the film core layer contains between about 10 and 25 weight percent semi-crystalline polymer.

In addition, the breathable filled film core layer may optionally include one or more stabilizers or processing aids. For instance, the filled-film may include an anti-oxidant such as, for example, a hindered phenol stabilizer. Commercially available anti-oxidants include, but are not limited to, IRGANOX E 17 (a-tocopherol) and IRGANOX 1076 (octodecyl 3,5-di-tert-butyl-4-hydroxyhydrocinnamate) which are available from Ciba Specialty Chemicals of Tarrytown, N.Y. In addition, other stabilizers or additives which are compatible with the film forming process, stretching and any subsequent lamination steps, may also be employed with the present invention. For example, additional additives may be added to impart desired characteristics to the film such as, for example, melt stabilizers, processing stabilizers, heat stabilizers, light stabilizers, heat aging stabilizers and other additives known to those skilled in the art. Generally, phosphite stabilizers (i.e. IRGAFOS 168 available from Ciba Specialty Chemicals of Tarrytown, N.Y. and DOVERPHOS available from Dover Chemical Corp. of Dover, Ohio) are good melt stabilizers whereas hindered amine stabilizers (i.e. CHIMASSORB 944 and 119 available from Ciba Specialty Chemicals of Tarrytown, N.Y.) are good heat and light stabilizers. Packages of one or more of the above stabilizers are commercially available such as B900 available from Ciba Specialty Chemicals. Desirably about 100 to 2000 ppm of the stabilizers are added to the base polymer(s) prior to extrusion (Parts per million is in reference to the entire weight of the filled-film).

Desirably, a concentrate of “filled polymer” (carrier resin and filler) is made for the core layer, with the filler and the semi-crystalline carrier polyolefin in the range of between about 60-85 percent by weight filler, but more desirably between about 70-85 percent by weight filler. It is also desirable to reduce the amount of the semi-crystalline polymer in the final composition so as to have the least impact on the elastic performance of the elastomeric polymer phase of the core layer. The elastic polymer is blended with the filled polymer concentrate resin prior to introduction into the film screw extruder in a blending station as a “letdown” resin. The concentration of the block polymer is then generally determined by the desired filler level in the final composition. The level of filler will necessarily affect breathability as well as elastic properties of the film core layer and ultimate multiple layered film. In one embodiment it is desirable for the filler to be present in the filled polymer concentrate in an amount of greater than 80 weight percent, such that the film demonstrates the desired properties which are described below.

As an example, the filler may be present in a film core layer of between about 25-65 weight percent, the elastomer may be present in a range between about 15-60 weight percent, and the semi-crystalline polymer may be present in a range of between about 5-30 weight percent.

It is desirable for the purposes of this invention, to limit as much as possible the semi-crystalline polymer to the surface of the filler (to maintain the carrier resin in close association with the filler), so as not to fully compound the carrier resin polymer or filler throughout the elastic polymer blend of the core layer, thereby limiting the mixing of the two polymers. The elastic polymer is then generally in a continuous phase throughout the film core layer, maximizing the elastic performance.

The one or more skin layers 228, 230 of the multilayered breathable elastic film 205 are desirably formed from a coextrusion process with the core layer, and processed along with the core layer in the stretching and other post formation processes. In one embodiment, the skin layers comprise between about 1 and 4 percent volume of the multilayered film. That is, if there are two skin layers on opposing sides of a core layer, each of a skin layer is between about 0.5 and 2 percent volume of the multilayered film. The core layer therefore in one embodiment is between about 96 and 99 volume percent of the multilayered film. In FIG. 1 two different skin layer formulations are illustrated. On one surface of the core a skin layer is shown with no filler present 228. On the opposing side of the core layer, a skin layer is present 230 which includes filler particles 237 in addition to the skin layer polymer 231. After the multilayered film 205 has been stretched, spaces do not only form in the core layer pockets 222, but also around the skin layer particles 237 to form pores 238. In an alternative embodiment, both skin layers include filler to enhance breathability.

The skin layer(s) of such a multilayered breathable and elastic film desirably do not hinder the elastic and breathable attributes of the core layer. Such skin layers desirably also provide additional functionality to the core layer features. For example, in one embodiment, it is desirable that skin layer(s) provide nonblocking functionality only. In such an embodiment, the skin layer(s) is selected from a lower density polyethylene, such as ExxonMobil LD 202 (LDPE) or others. Such a material demonstrates a 12 MI and a density of 0.915 g/cc. It is desirable in one embodiment for the skin layers to be formed from a polymer with a melt index of between about 10 and 15, and a density of between about 0.915 and 0.923 g/cc. Other examples of skin layer polymers include DOWLEX™ 4010 (10 MI, 0.918 g/cc), DOWLEX™ 4012 (12 MI, 0.918 g/cc), and from Equistar Corp., PETROTHENE NA 206.000 (13.5 MI, 0.918 g/cc), and PETROTHENE NA 219.000 (10 MI, 0.923 g/cc). In an alternative embodiment, such skin layers are produced from elastic polypropylene or elastic ethylene-propylene copolymers.

In an alternative embodiment, at least one such skin layer includes filler such as calcium carbonate along with a polyethylene base resin in order to enhance the printability attributes of such multilayered film, reduce the blocking of such film even further, and also to provide enhanced bonding capability of such film to other sheet materials with the use of adhesives. If such filler is present, it is desirably present in an amount of between about 5 and 50 weight percent of the skin layer(s). In an alternative embodiment, the filler is present in at least one skin layer in an amount of between about 10 and 50 weight percent. In still a further alternative embodiment, the filler is present in an amount of between about 20 and 35 percent by weight.

It is desirable in one embodiment for such multi-layered elastic film to be breathable such that it demonstrates a breathability (WVTR) of at least about 100 g/m²/24 hours. In a second embodiment, such film demonstrates a WVTR of at least about 1000 g/m²/24 hours.

As can be seen in FIG. 1, a printed image 240 has been placed on the particle filled skin layer 230 of the multilayered film 205. Such fillers may additionally serve as antiblocking agents. Antiblock agents include diatomaceous earth such as CELITE 263 and SUPERFLOSS from the Celite Corp., and talc, such as Talc 9610 of Barret Minerals.

NonBreathable Non-Blocking Elastic Film

In an alternate embodiment of an elastomeric film with reduced blocking attributes, a monolayer or desirably multilayered nonbreathable film may be formed from specific polymers. While such alternate embodiment of elastomeric films is not breathable as described for the previous embodiments, such films demonstrate enhanced nonblocking attributes and elastic functionality. The specific film formulations may be extruded directly to another sheet material, such as a woven or nonwoven material as a coating. Alternatively, such film can be laminated after it has cooled or further processed (such as by being slit) or wound upon a roll for storage. In this fashion, this film (as in the previous embodiments) can be stored for later usage without concern for film failure upon being unwound. Such film can also be post treated, such as by exposure to corona treatment or stretched, or still further, annealed and retracted in the MD direction to further improve its antiblocking properties.

Such films may include a monolayer as illustrated in FIG. 1A having one component polymer 241, or at least three layers 242 as illustrated in FIG. 1B, of a core layer 246 and at least two skin layers 244. In the three layer embodiment, the skin layers 244 are desirably comprised of between about 75 and 100 percent polyolefin-based elastomeric material, and between about 0 and 25 percent of at least one additional compound of a resin with at least 5 percent antiblock agent. In an alternative embodiment, such compound itself includes a polyolefin based resin and diatomaceous earth as an antiblock agent. In still a further alternative embodiment, such compound is present in an amount of between about 8 and 15 weight percent of the skin layers, alternatively between about 8 and 12 weight percent. Desirably the core of such a three layer film is in one embodiment about 100 percent polyolefin based elastomer material. In an alternative embodiment, the core layer of the three layered film is between about 95 and 97 volume percent of the film. Still in a further alternative embodiment of the core layer of the three layered nonbreathable elastic film, the core layer is a blend of between about 50/50 to 80/20 of a polyolefin based elastomer and a styrene block copolymer. For example, such core layer is a blend of a polyethylene such as AFFINITY EG8200 and E.G. CALPRENE C-500 or a polyethylene with a KRATON G polymer such as KRATON G 1657. Additionally, pigments can be added to the film, such as in a core layer to add color to the film. For example, titanium dioxide may be added to the film to produce a white/opaque color.

It is desirable in one embodiment of the three layer nonbreathable embodiment, that the skin layers comprise between about 1 and 20 percent of the three layered film, and that the core layer comprises between about 80 and 99 percent of the film. In an alternative, the skin layers comprise between about 2 and 20 volume percent and the core comprise between 80 and 98 volume percent of the film. Polyolefin elastomers that may be used in the film (skin and/or core) include single site catalyzed polyolefins, such as metallocene-catalyzed and constrained geometry polymers. Such polymers include those available from Dow Chemical or ExxonMobil under the designations AFFINITY and EXACT. Specific examples include Dow, AFFINITY EG8200, EG 8185, PT 1409, and ExxonMobil EXACT 3139, 3131, 4150, 3024. Examples of antiblocking agents include CELITE 263 and Celite SUPERFLOSS from the Celite Corporation.

Examples of styrenic block copolymers that are useful in the embodiment include saturated and unsaturated block copolymers such as KRATON D and KRATON G type block copolymers available from Kraton Polymers, or alternatively other styrenic block copolymers from Septon Company of America, Dynasol, and Dexco.

In an alternative embodiment of the invention, each of the nonblocking film embodiments described above (either the breathable or nonbreathable) can be laminated to one or more additional sheet material layers as part of a multi-layered laminate. For instance, the nonblocking film can be laminated to one or more nonwoven webs, woven webs or scrims. In one embodiment, the film can be laminated to a spunbond web. Such spunbond web can be of a single component, or alternatively of a bicomponent/conjugate fiber arrangement. Desirably, such spunbond web has a basis weight of between about 10 and 50 gsm.

A variety of thermoplastic polymeric materials can be utilized in the nonwoven webs. Such thermoplastic substances include, but are not limited to, polyolefins, polyesters, polyamides, polycarbonates, polyurethanes, polyvinyl chloride, polytetrafluoroethylene, polystyrene, polyethylene terephathalate, biodegradable polymers such as polylactic acid, and so forth, as well as combinations comprising at least one of the foregoing thermoplastic polymeric substances. Suitable polyolefins include, but are not limited to, polyethylene, e.g., high density polyethylene, medium density polyethylene, low density polyethylene, and linear low density polyethylene; polypropylene, e.g., isotactic polypropylene, syndiotactic polypropylene, blends of isotactic polypropylene and atactic polypropylene; polybutylene, e.g., poly(1-butene) and poly(2-butene); polypentene, e.g., poly(1-pentene) and poly(2-pentene); poly(3-methyl-1-pentene); poly(4-methyl 1-pentene); and so forth, as well as combinations comprising at least one of the foregoing. Suitable copolymers include random and block copolymers prepared from two or more different unsaturated olefin monomers, such as ethylene/propylene and ethylene/butylene copolymers. Suitable polyamides include nylon 6, nylon 6/6, nylon 4/6, nylon 11, nylon 12, nylon 6/10, nylon 6/12, nylon 12/12, copolymers of caprolactam and alkylene oxide diamine, and the like, as well as combinations comprising at least one of the foregoing polyamides. Suitable polyesters include polyethylene terephthalate, polytrimethylene terephthalate, polybutylene terephthalate, polytetramethylene terephthalate, polycyclohexylene-1,4-di-methylene terephthalate, and isophthalate, and so forth, as well as copolymers and combinations comprising at least one of the foregoing.

The nonwoven material can be formed by a variety of processes in addition to the previously described spunbond process (S) including airlaying, melt-blowing (M), bonded carded web formation processes, coform processes and so forth, as well as combinations comprising at least one of the foregoing. The nonwoven material can be formed, for example, from a single spunbond bank (e.g., S), or multiple banks (e.g., S in combination with other bank(s)), e.g., SS, SSS, SMS, SSMMS, and so forth, wherein M refers to meltblown fibers). All such nonwoven webs may be pre-bonded, using nonwoven web bonding techniques, and/or bonded using the pattern-unbonded method and apparatus such as described in U.S. Pat. No. 5,858,515 to Stokes et al. The nonwoven material can have fibers of about 0.8 to about 10 denier per filament (dpf), or, more specifically, about 1.5 to about 7 dpf, or, even more specifically, about 1.5 dpf to about 5 dpf, and, yet more specifically, about 1.8 dpf to about 3 dpf.

The nonwoven web may be embossed and/or matte finished, and/or printed, to provide a more aesthetically pleasing appearance,. When printed, “reactive” inks (e.g., inks which change color or color intensity upon contact with some triggering mechanism, such as moisture/water, heat, ultraviolet (UV), and the like may desirably be used to provide additional visual cues. These visual cues could be ornamental and/or can be functional, e.g., advising that the product needs to be changed due to its saturation level.

Such film/nonwoven laminates may include additional nonwoven layers on one or both sides of the film. For example such laminates may be nonwoven /film/nonwoven laminate structures, which may be particularly effective as components of personal care products, such as elastic ear attachment substrates, wipes, barrier sheets, and so forth.

Additionally, depending upon the desired application, in alternative embodiments, the nonwoven material(s) can comprise softening additives to impart a softened texture the nonwoven material. In some cases, the nonwoven can comprise botanical(s), ointment(s), skin wellness additive(s) (e.g., that can help to protect a user's skin in the areas of contact), and so forth. Examples of such botanicals, ointments, and additives include: aloe vera, cotton extract, chamomile, jojoba, sunflower oil, citric oils, carrot oils, avocado oil, almond oil, wheat germ, mint, olive oil, vitamins (e.g., E, D, A, and so forth), isopropyl palmitate, eucalyptus oil, lavender, peppermint oil, and so forth, as well as derivatives thereof, and combinations comprising at least one of the foregoing. Other optional ingredients include, but are not limited to, alkyldimethyl benzylammonium chloride, allontoin (5-ureidohydantoin), aluminum acetate, aluminum hydroxide, amylum, balsam peru, benzethonium chloride, bismuth subnitrate, boric acid, calamine, calcium carbonate, camphor, casein, cod liver oil, cysteine hydrocholyde, dibucaine, disperodon, glycerin, lanolin, petrolatum, phenol, silicone sorbitane, talc, zinc oxide, zinc, and so forth, as well as combinations comprising at least one of the foregoing. Perfumes and fragrances can optionally be applied to the formulation to enhance the user's perception of an absorbent article product, and/or to help mask, hide, or neutralize odors.

The film may be laminated to additional sheet materials by adhesive bonding, thermal calendering, extrusion coating, ultrasonic bonding or a combination of these methods. In some instances, the layer that is laminated to the film may provide support to the film, and may be fairly characterized as a support layer. In other instances such additional layer may provide other types of functionality, such as an improved hand. Such film/nonwoven laminates may be particularly effective as components of personal care products, such as elastic ear attachment substrates (as described below).

As can be seen in FIGS. 1C and 2, such film/nonwoven laminates are illustrated. In FIG. 1C a film laminate is illustrated with a multilayered nonbreathable film 249 and a nonwoven web 253. The film is laminated to the web by an adhesive layer 251, and is made from three layers, including a core layer 245 and two skin layers 243, 247. In FIG. 2 a film laminate of the current invention is illustrated having a multi-layered breathable elastic (and nonblocking) film 205 and at least one additional attached support layer such as a nonwoven layer 236. Such nonwoven layer is attached to a skin layer of the multi-layered film 234, by for instance an adhesive application 235. As is illustrated in FIG. 2, such multi-layered film may include a printed image on one surface which can be seen through the nonwoven layer 236 from direction 250. In some cases these graphics can be randomly placed in the product or selectively placed, depending on whether a visual cue is desired. Alternatively, such printing may be onto the nonwoven layer. Such a construction may for example serve as an outercover of a personal care product/article, where the film layer is facing the skin of the user of such a product and the nonwoven layer is facing away from the skin of the user.

Process:

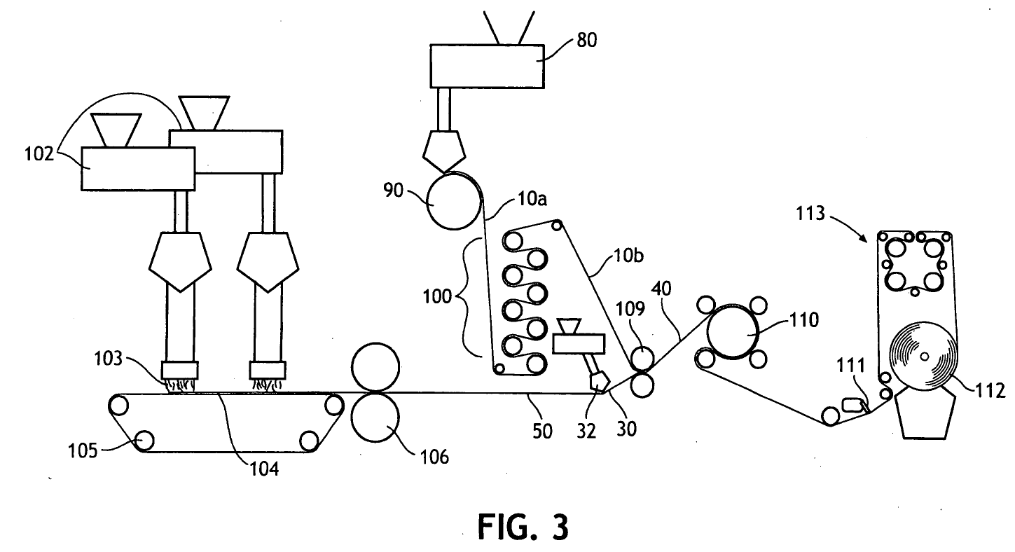

A process for forming the breathable, elastic film 10 is shown in FIG. 3 of the drawings moving from left to right. If a nonbreathable film is desired, steps involving stretching would be eliminated, or the specific polymers would be utilized as previously described. Before the breathable elastic film is manufactured, the raw materials, i.e. the semi-crystalline carrier polymer(s) and filler (as in the breathable film) must first be compounded such as through the following process. The filler and semi-crystalline polymer raw materials are added into a hopper of a twin screw extruder or high intensity mixer, (both available from Farrel Corporation, of Ansonia Conn.) and are dispersively mixed in the melt, by the action of the intermeshing rotating screws or rotors. The resulting mixture is pelletized and is referred to herein as the filler concentrate or filler concentrate compound. The filler concentrate compound and the elastomer resin are then desirably processed in a film process by means of a single, barrier screw extruder, followed by a melt pump feeding a film die. It should therefore be recognized that the materials are not all fully compounded together in one step, rather it is a separate step process that accomplishes the compounding of the carrier polymer with the filler and then another step which combines the filled carrier resin and the thermoplastic elastomer.

Referring again to the Figure, the compounded polymers and filler are placed in an extruder 80 apparatus and then cast or blown into a film. A precursor film 10a is then extruded (at a temperature range of between about 380-440° F., Examples in the range of 400-420° F.) onto for instance, a casting roll 90, which may be smooth or patterned. If a multilayered film is to be produced, the multiple layers are coextruded together onto the casting roll. For example, three extruders would help to extrude three layers side by side through a film die. The term “precursor” film shall be used to refer to the film prior to being made breathable, such as by being run through a machine direction orienter. The flow out of the extruder die is immediately cooled on the casting roll 90. A vacuum box (not shown) may be situated adjacent the casting roll in order to create a vacuum along the surface of the roll to help maintain the precursor film 10a lying close to the surface of the roll. Additionally, air knives or electrostatic pinners (not shown) may assist in forcing the precursor film 10a to the casting roll surface as it moves around the spinning roll. An air knife is a device known in the art which focuses a stream of air at a very high flow rate to the edges of the extruded polymer material. The precursor film 10a (prior to run through the MDO) is desirably between about 20 and 100 microns in thickness, and has an overall basis weight of between about 30 gsm and 100 gsm. In one embodiment the basis weight is between about 50-75 gsm. Following stretching in a stretching apparatus, the basis weight of the film is between about 10 and 60 gsm, but desirably between about 15 and 60 gsm.

As previously stated, the precursor film 10a is subjected to further processing to make it breathable. Therefore, from the extrusion apparatus 80, and casting roll 90, the precursor film 10a is directed to a film stretching unit 100, such as a machine direction orienter or “MDO” which is a commercially available device from vendors such as the Marshall and Williams Company of Providence, R.I. This apparatus may have a plurality of stretching rollers (such as for example from 5 to 8) which progressively stretch and thin the film in the machine direction, which is the direction of travel of the film through the process as shown in FIG. 3. While the MDO is illustrated with eight rolls, it should be understood that the number of rolls may be higher or lower, depending on the level of stretch that is desired and the degrees of stretching between each roll. The film can be stretched in either single or multiple discrete stretching operations. It should be noted that some of the rolls in an MDO apparatus may not be operating at progressively higher speeds.

Desirably, the unstretched filled film 10a (precursor film) will be stretched (oriented) from about 2 to about 5 times its original length, imparting a final stretch of between 1.5 to about 4 times of the original film length after the film is allowed to relax at the winder. In an alternative embodiment, the film may be stretched through intermeshing grooved rolls such as those described in U.S. Pat. No. 4,153,751 to Schwarz.

Referring again to FIG. 3, some of the rolls of the MDO 100 may act as preheat rolls. If present, these first few rolls heat the film above room temperature (125° F.). The progressively faster speeds of adjacent rolls in the MDO act to stretch the filled precursor film 10a. The rate at which the stretch rolls rotate determines the amount of stretch in the film and final film weight. Microvoids are formed during this stretching to render the film microporous and subsequently breathable. After stretching, the stretched film 10b may be allowed to slightly retract and/or be further heated or annealed by one or more heated rolls 113, such as by heated anneal rolls. These rolls are typically heated to about 150-220° F. to anneal the film. The film may then be cooled. After exiting the MDO film stretching unit, the then breathable product film 10 (which includes a core and at least one skin layer) may be wound on a winder for storage or proceed for further processing.

If desired, the produced product film 10 may be attached to one or more layers 50, such as nonwoven layers (for instance, spunbond), to form a multilayer film/laminate 40. Suitable laminate materials include nonwoven fabrics, multi-layered nonwoven fabrics or sheet materials, scrims, woven fabrics and other like materials. In order to achieve a laminate with improved body conformance, the fibrous layer is itself desirably an extensible fabric and even more desirably an elastic fabric. For example, tensioning a nonwoven fabric in the MD causes the fabric to “neck” or narrow in the CD and give the necked fabric CD extensibility. Examples of additional suitable extensible and/or elastic fabrics include, but are not limited to, those described in U.S. Pat. No. 4,443,513 to Meitner et al.; U.S. Pat. No. 5,116,662 to Morman et al.; U.S. Pat. No. 4,965,122 to Morman et al.; U.S. Pat. No. 5,336,545 to Morman et al.; U.S. Pat. No. 4,720,415 to Vander Wielen et al.; U.S. Pat. No. 4,789,699 to Kieffer et al.; U.S. Pat. No. 5,332,613 to Taylor et al.; U.S. Pat. No. 5,288,791 to Collier et al.; U.S. Pat. No. 4,663,220 to Wisneski et al.; and U.S. Pat. No. 5,540,976 to Shawver et al. The entire content of the aforesaid patents are incorporated herein by reference. Such necked nonwoven material may be bonded to the film of the present invention. In an alternative embodiment, a slit and necked nonwoven material may be bonded to the film of the present invention. In still a further alternative embodiment, a spunbond support layer may be stretched in grooved rolls from between about 1.2 to 3× in the CD and then necked to the original width or to match the width of the film prior to being adhesively laminated to the film.

Nonwoven fabrics which may be laminated to such product films 10 desirably have a basis weight between about 10 g/m² and 50 g/m² and even more desirably between about 15 g/m² and 30 g/m². As a particular example, a 17 g/m² (0.5 ounces per square yard) web of polypropylene spunbond fibers can be necked a desired amount and thereafter laminated to a breathable stretched filled-product film 10. The product film 10 would therefore be nipped (in an adhesive nip, or lamination rolls of a calender roll assembly 109) to a necked or CD stretchable spunbond nonwoven web.

The spunbond layer, support layer, or other functional laminate layer may either be provided from a pre-formed roll, or alternatively, be manufactured in-line with the film and brought together shortly after manufacture. For instance, as is illustrated in FIG. 3, one or more spunbond extruders 102 meltspin spunbond fibers 103 onto a forming wire 104 that is part of a continuous belt arrangement. The continuous belt circulates around a series of rollers 105. A vacuum (not shown) may be utilized to maintain the fibers on the forming wire. The fibers may be compressed via compaction rolls 106. Following compaction, the spunbond or other nonwoven material layer is bonded to the product film 10. Such bonding may occur through adhesive bonding, such as through slot or spray adhesive systems, thermal bonding or other bonding means, such as ultrasonic, microwave, extrusion coating and/or compressive force or energy. An adhesive bonding system 32 is illustrated. Such a system may be a spray or a slot coat adhesive system. Examples of suitable adhesives that may be used in the practice of the invention include Rextac 2730, 2723 available from Huntsman Polymers of Houston, Tex., as well as adhesives available from Bostik Findley, Inc, of Wauwatosa, Wis. In an alternative embodiment, the film and nonwoven support layer are laminated with an adhesive such that the basis weight of the adhesive is between about 1.0 and 3.0 gsm. The type and basis weight of the adhesive used will be determined on the elastic attributes desired in the final laminate and end use. In another alternative embodiment, the adhesive is applied directly to the nonwoven support layer prior to lamination with the film. In order to achieve improved drape, the adhesive may be pattern applied to the outer fibrous layer.

The film and support layer material typically enter the lamination rolls at the same rate as the film exits the MDO if present. Alternatively, the film is tensioned or relaxed as it is laminated to the support layer. In an alternative embodiment, bonding agents or tackifiers may be added to the film to improve adhesion of the layers. As previously stated, the filled-multilayered film and fibrous layer can be adhesively laminated to one another. By applying the adhesive to the outer fibrous layer, such as a nonwoven fabric, the adhesive will generally only overlie the film at fiber contact points and thus provide a laminate with improved drape and/or breathability. Additional bonding aids or tackifiers can also be used in the fibrous or other outer layer.

After bonding, the laminate 40 may be further processed. Following lamination, the multilayered laminate may be subjected to numerous post-stretching manufacturing processes. For instance, such laminate may be slit, necked, apertured or printed. Alternatively, such laminate may be coursed through a series of grooved rolls that have grooves in either the CD or MD direction, or a combination of such. Such processing step 110 may provide additional desired attributes to the laminate 40, such as softness, without sacrificing elasticity or breathability. For instance, the grooved rolls may be constructed of steel or other hard material (such as a hard rubber) and may include between about 4 and 15 grooves per inch. In an alternative embodiment the grooved rolls may include between about 6 and 12 grooves per inch. In still a further alternative embodiment the grooved rolls include between about 8 and 10 grooves per inch. In still a further alternative embodiment grooves on such rolls include valleys of between about 100 thousandths and 25 thousandths of an inch. Exemplary groove roll and stretching processes and apparatus are described in U.S. Pat. No. 4,153,751 to Schwarz, Application WO2004/020174 for Device and Process for Treating Flexible Web By Stretching Between Intermeshing Forming Surfaces to Robert Gerndt et al., filed Aug. 22, 2003, and U.S. application Ser. No. 10/881,064 to Michael T. Morman, for Efficient Necked Bonded Laminates and Methods of Making Same, filed Jun. 30, 2004, each incorporated by reference in its entirety.

Following any additional treatment, the laminate may be further slit, 111, annealed 113, and/or wound on a winder 112.

The inventive film and/or film laminate may be incorporated into numerous personal care products. For instance, such materials may be particularly advantageous as a stretchable outer cover for various personal care products. Additionally, such film may be incorporated as a base fabric material in protective garments such as surgical or hospital drapes/gowns. In still a further alternative embodiment, such material may serve as a base fabric for protective recreational covers such as car covers and the like.

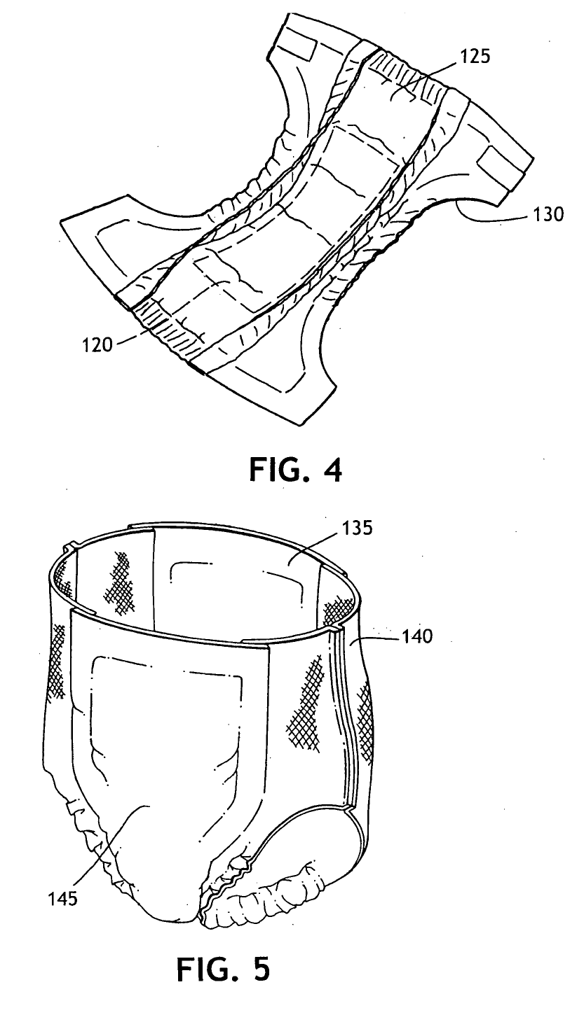

In this regard, FIG. 4 is a perspective view of an absorbent article, such as a disposable diaper of the present invention, in its opened state. The surface of the diaper which contacts the wearer is facing the viewer. With reference to FIG. 4, the disposable diaper generally defines a front waist section, a rear waist section, and an intermediate section which interconnects the front and rear waist sections. The front and rear waist sections include the general portions of the article which are constructed to extend substantially over the wearer's front and rear abdominal regions, respectively, during use. The intermediate section of the article includes the general portion of the article that is constructed to extend through the wearer's crotch region between the legs.

The absorbent article includes an outer cover 130, a liquid permeable bodyside liner 125 positioned in facing relation with the outer cover, and an absorbent body 120, such as an absorbent pad, which is located between the outer cover and the bodyside liner. The outer cover in the illustrated embodiment, coincide with the length and width of the diaper. The absorbent body generally defines a length and width that are less than the length and width of the outer cover, respectively. Thus, marginal portions of the diaper, such as marginal sections of the outer cover, may extend past the terminal edges of the absorbent body. In the illustrated embodiment, for example, the outer cover extends outwardly beyond the terminal marginal edges of the absorbent body to form side margins and end margins of the diaper. The bodyside liner is generally coextensive with the outer cover but may optionally cover an area which is larger or smaller than the area of the outer cover, as desired.

The outer cover and bodyside liner are intended to face the garment and body of the wearer, respectively, while in use. The film or film laminates of the present invention may conveniently serve as the outercover in such an article or the attachment ear portions 131 of the diaper.

Fastening means, such as hook and loop fasteners, may be employed to secure the diaper on a wearer. Alternatively, other fastening means, such as buttons, pins, snaps, adhesive tape fasteners, cohesives, mushroom-and-loop fasteners, or the like, may be employed.

The diaper may also include a surge management layer located between the bodyside liner and the absorbent body to prevent pooling of the fluid exudates and further improve the distribution of the fluid exudates within the diaper. The diaper may further include a ventilation layer (not illustrated) located between the absorbent body and the outer cover to insulate the outer cover from the absorbent body to reduce the dampness of the garment facing surface of the outer cover.

The various components of the diaper are integrally assembled together employing various types of suitable attachment means, such as adhesive, sonic bonds, thermal bonds or combinations thereof. In the shown embodiment, for example, the bodyside liner and outercover may be assembled to each other and to the absorbent body with lines of adhesive, such as a hotmelt, pressure-sensitive adhesive. Similarly, other diaper components, such as the elastic members and fastening members, and the surge layer may be assembled into the article by employing the above-identified attachment mechanisms. The article of the invention desirably includes the distinctive film or film laminate as a stretchable fabric layer as part of a stretchable outer cover which is operatively attached or otherwise joined to extend over a major portion of the outward surface of the article. In regions where the stretchable outer cover is not affixed to non-stretchable portions of the article or otherwise restricted from extending, the stretchable outer cover can be free to advantageously expand with minimal force. In desired aspects, the outer cover can be stretchable along the longitudinal direction, lateral direction, or along a combination of both the lateral and longitudinal directions. In particular, it is desirable that at least the portion of the stretchable outer cover located in the waist sections be capable of extending in the lateral direction to provide improved fastening of the article about the wearer and improved coverage of the hips and buttocks of the wearer particularly in the rear waist section and enhanced breathability in the waist sections. For example, if the fasteners and/or side panels are located along the side edges in the rear waist section of the diaper, at least a portion of the outer cover in the rear waist section will desirably extend to provide enhanced coverage over the buttocks of the wearer in use for improved containment and aesthetics. In a further alternative embodiment, the distinctive film of the invention may serve as a base material for stretchable ears/fastening tabs on the outer cover as well as previously described. In still another alternative embodiment of the present invention, the distinctive film may serve as the basis of a stretchable liner. In such an embodiment, the liner may be apertured. In still another alternative embodiment, the distinctive film may serve as a full stretchable outercover which encompasses both the front and rear areas of a personal care article, including stretchable side areas. This would eliminate the need to utilize distinct side panels in certain articles.

Moreover, it is also desirable that at least portions of the stretchable outer cover located over the absorbent body can extend during use for improved containment. For example, as the absorbent body absorbs fluid exudates and expands outwardly, the stretchable outer cover can readily elongate and extend in correspondence with the expansion of the absorbent body and/or other components of the article to provide void volume to more effectively contain the exudates. The stretchable outer cover of the present invention is desirably capable of providing a selected stretch when subjected to an applied tensile force, and the ability to retract upon removal of such applied force.

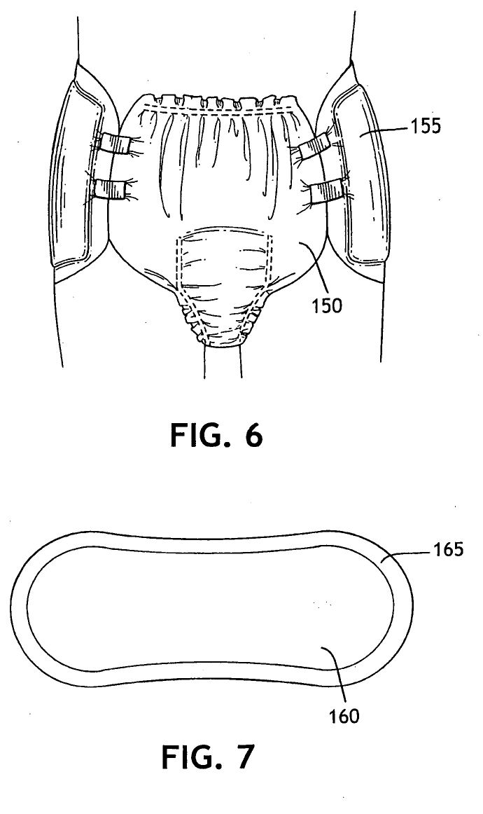

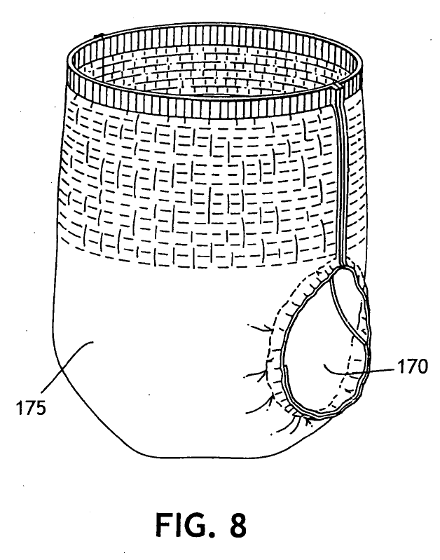

As can be seen in the various other absorbent personal care product embodiments, the inventive material may be used as an “outer cover” in a variety of product applications including a training pant, an underwear/underpant, feminine care product, and adult incontinence product. As an outercover, such material may be present in film form, or alternatively as a laminate in which a nonwoven or other sheet material has been laminated to the film layer. For instance, as can be seen in FIG. 5, the distinctive film can serve as the outer cover on both the back 135 and front portions of a training pant, separated by separate elastic side panels 140. As previously stated, such outercover may encompass the side panel areas in an alternative embodiment. As can be seen in FIG. 6, the distinctive film can serve as an outer cover in an underpants such as either 150 or 155. As can be seen in FIG. 7, the distinctive film can serve as an outercover/backsheet 165 in a feminine care pantiliner 160. As can be seen in FIG. 8, the distinctive film can serve in an adult incontinence product as an outercover 175. Additionally such film or film laminates may serve as a sanitary napkin coversheet. Such film or film laminates may be further processed such as by being apertured and the like, before being used as base materials in such products.

A series of examples were developed to demonstrate and distinguish the attributes of the present invention. Such examples are not presented to be limiting, but in order to demonstrate various attributes of the inventive material.

### EXAMPLES OF ONLY CORE LAYER FOR BREATHABLE NONBLOCKING ELASTIC FILM

### Example 1

In Example 1 an inventive film core layer was produced. The film core layer contained calcium carbonate filler dispersed in a carrier resin. The calcium carbonate, was available from OMYA, Inc., North America of Proctor, Vt. under the designation OMYACARB 2 SS T and had an average particle size of 2 micron, top cut of 8-10 microns and about 1% stearic acid coating. The calcium carbonate (75%) filler and carrier resin (25%), DOWLEX™ 2517 LLDPE (melt index of 25 and density of 0.917) formed the filler concentrate compound that was then blended in a single screw conventional extruder with 33% of SEPTON 2004 SEPS triblock thermoplastic elastomer letdown resin to provide a final calcium carbonate concentration of 50.25% by weight. The DOWLEX™ polymer is available from Dow Chemical U.S.A. of Midland, Mich. The Septon polymer is available from Septon Company of America of Pasadena, Tex.

This formulation was formed into a film core layer by casting onto a chill roll set to 104° F. at an unstretched basis weight of 64 gsm. The film (core layer) was stretched 3.6 times its original length using a machine direction orienter (MDO), then retracted 35% to a stretched basis weight of 33.9 gsm. As used herein, reference to stretching the film 3.6 times means that the film which, for example, had an initial length of 1 meter if stretched 3.6 times would have a final length of 3.6 meters. The film was heated to a temperature of 125° F. and was run through the MDO at a line speed of 492 feet per minute to provide the desired stretch. The film was then annealed at a temperature of 160-180° F. across multiple rolls.

### Example 2

In Example 2, a film core layer similar to the film of Example 1, but with 30% of SEPTON 2004 SEPS triblock thermoplastic elastomer letdown resin was formulated to provide a final calcium carbonate filler concentration of 52.5% by weight.

This formulation was formed into a film core layer by casting onto a chill roll set to 99° F. at an unstretched basis weight of 64.4 gsm. The film was stretched 3.6 times its original length using a machine direction orienter (MDO), then retracted 15% to a stretched basis weight of 30.6 gsm. The film was heated to a temperature of 125° F. and was run through the MDO at a line speed of 472 feet per minute to provide the desired level of stretch. The film was then annealed at temperatures of between 160-200° F. across multiple rolls.

TABLE 1

| 70% | | | | | 2^{nd} | 2^{nd} | |
|---|---|---|---|---|---|---|---|
| Elongation | Mocon | 1^{st} Load | 1^{st} Load | Load | Load | Load | |
| and | g/m²/ | @ 50% | @ 50% | @ 50% | @ 50% | Loss | % |
| 2 cycle | 24 hr | up/gf | dn/gf | up/gf | dn/gf | % | Set |
| Example 1 | 856 | 275 | 182 | 233 | 175 | 36.1 | 8.5 |
| Example 2 | 4978 | 246 | 145 | 204 | 138 | 44.0 | 13.3 |

For the purposes of the Table I, the abbreviation up/gf refers to the extension/elongation (up) tension on the cycle test in grams-force, and the abbreviation dn/gf refers to “retraction” (down) tension on the cycle test in grams-force. Elastic-type Testing was done in the CD direction, and therefore values reflect CD direction elastic performance. It is desirable that such films demonstrate load loss values less than about 50 percent. More desirably, such films should demonstrate a load loss of less than about 45 percent. Still even more desirably, such films should demonstrate a load loss of less than about 35 percent. Each of the load loss values are at 50 percent elongation in accordance with the described cycle test. Load loss is expressed in a percentage, as is set.

A filled breathable elastic core layer is therefore provided that provides elasticity without sacrificing breathability. Such elasticity is not compromised by the use of filler to create micropores. However, such single layer films either fail to easily unwind from a storage roll or unwind with damage to the film.

### EXAMPLES OF FILLED BREATHABLE FILM UTILIZING ABOVE CORE LAYER WITH ENHANCED SKIN LAYERS

Samples of the above film layer were then coextruded with various skin layers. The film samples were made in accordance with the following conditions. The LDPE used in the examples was Exxon Mobil LD 202 (12 MI, 0.915 density).

A control film sample was produced (monolayer) with 33 percent SEPTON 2004 and 67 percent carrier and filler as previously described. The control consisted of a monolayered film without skin layers. Numerous multilayered films were then produced with the same core layer as the control, as noted below.

The following core/skin formulations were evaluated. A core with 33 percent Septon and 67 percent filler/carrier blend was coextruded with a skin blend of 53 percent LDPE 202 and 47 percent calcium carbonate (as described below). Additionally, other skin layers were formulated with blends of various polyethylenes and catalloy materials, ethylene vinylacetate and catalloy polymers, with and without various antiblock materials. The following process conditions were employed. The core extruder was 3.5 inches and the skin extruder was 1.5 inches.

Polymer blends were formed into a film composition with a die temperature of 420° F. by casting onto a chill roll set to 110° F. at a chill roll speed of 125 feet per minute to achieve a targeted un-stretched basis weight of 60 gsm. The film was then stretched 3.8 times the original length using a machine direction orientor at a roll speed of 536 feet per minute. The normal range-of percent stretch is generally between 3.5 and 4.1 times (ratio used about 3.85 times). The temperature of the stretch rolls within the machine direction orientor was 120° F. Then the film was annealed within the MDO at a temperature of 170° F. (a range of annealing temperature would be between about 150° and 180° F.). The material was then allowed to retract between 20-25 percent with annealing, followed by chilling at about 60° F. These materials were then wound on a roll at a speed of 430 feet per minute. The final basis weight achieved was about 32 gsm. The films with skin had two skins, one each side of the core, with the core volume percentage at 98 percent and the skin volume percentage at 2 percent (1 percent for each skin layer).

A series of tests were then conducted on the controls and multilayered breathable elastic films to assess nonblocking attributes and various other properties. The tests are reflected below.

The coefficient of friction test was run on the various films, with the following results. The coefficient of friction for the control film without skins (with retraction) blocked severely, while the coefficient of friction for an EVA/catalloy skin, exhibited a reduced blocking level, but still comparatively high. The coefficient of friction for the skin layer film with calcium carbonate filled polyethylene did not block at all.

Data from a tack test was then taken at ambient conditions. Tack is the measured force in grams to separate the film from the plastic foot of the tester. A higher level of tack correlates to a higher level of blocking. It should be recognized that the film was removed from the film roll with the following dimensions. The film roll dimension was about 15-20 inches in width, including a core of 3 inch diameter. The diameter of the film covered roll was about 6-9 inches. The rolls were stored at ambient conditions for 1-3 months before testing, unless otherwise noted.

TABLE 2

| | | | | | | | Peel |
|---|---|---|---|---|---|---|---|
| | | | | | | | Test/ |
| | | | | | | | Room |
| | | | | | | | Temp. |
| Film | | | | | | Avg. | Avg. |
| Formulation | Samp. 1 | Samp. 2 | Samp. 3 | Samp. 4 | Samp. 5 | Tack (g) | Load (g) |
| Control w/o | 39 | 38 | 38 | 38 | 43 | 39 | 36 |
| skin (with | | | | | | | |
| 25% | | | | | | | |
| retraction) | | | | | | | |
| Control with 2 | 14 | 13 | 18 | 12 | 16 | 14 | 0 |
| skin blend of | | | | | | | |
| 47% calcium | | | | | | | |
| carbonate | | | | | | | |
| and 53% | | | | | | | |
| ExxonMobil | | | | | | | |
| LDPE LD-202 | | | | | | | |
| Control with 2 | 16 | 14 | 18 | 14 | 13 | 15 | 0 |
| skins of 90% | | | | | | | |
| ExxonMobil | | | | | | | |
| LDPE LD- | | | | | | | |
| 202, 10% | | | | | | | |
| antiblock. | | | | | | | |
| Control with 2 | 63 | 58 | 70 | 64 | 79 | 67 | 56 |
| skins of 90% | | | | | | | |
| EVA Catalloy | | | | | | | |
| blend and 10% | | | | | | | |
| antiblock | | | | | | | |
| Control with 2 | 45 | 43 | 41 | 41 | 47 | 43 | Not |
| skins Catalloy | | | | | | | avail. |
| and LDPE | | | | | | | |
| blend | | | | | | | |

It should be noted that for the purposes of the above formulations, the 47% calcium carbonate actually consisted of a concentrate of calcium carbonate which included 75 percent calcium carbonate in DOWLEX™ 2517 LLDPE of Dow. In embodiments that included 90 percent ExxonMobil LD 202 (LDPE) or other material and 10 percent antiblock, the antiblock actually comprised 80% Dow AFFINITY EG 8185 and 20% Celite 263. The catalloy polymer utilized was Basell KS 357 P. The EVA consisted of Exxon Mobil LD 761.36 and LD 755.12. The catalloy was present in about 50% and each of the EVA's were present at about 25%. In the catalloy and LDPE blend, the catalloy was present in about 60% and the LDPE was present in about 40%, this blend also included Bayer Buna 2070. The numbers in the table were rounded to the “ones” significant digit.

The films with and without skin layers demonstrated comparable breathability and elastic performance as seen in the data of the following Table 3.

TABLE 3

| | | Load | | | | | |
|---|---|---|---|---|---|---|---|
| | | Up | Load Dn | | | | |
| | Basis | @ 50% | @ 50% | | | % | WVTR |
| Film | Weight | 1^{st} Cycl. | 2^{nd} Cycl. | % | | Load | Avg. |
| Formula | (gsm) | (g) | (g) | Hyst. | % Set | Loss | g/m2/24 |
| Control/ | 33 | 243 | 150 | 34 | 11 | 38 | 2100 |
| No skins | | | | | | | |
| Control | 41 | 266 | 191 | 57 | 11.2 | 39 | 1650 |
| with 53% | | | | | | | |
| 202 and | | | | | | | |
| 47% | | | | | | | |
| Calcium | | | | | | | |
| Carb. | | | | | | | |
| skins | | | | | | | |
| Control | 31 | 300 | 143 | 44 | 17 | 52 | 2200 |
| with 100% | | | | | | | |
| 202 | | | | | | | |
| skins. | | | | | | | |

It is known that film blocking on a roll can occur due to a combination of factors. The above analysis focussed on the effect of film chemistry (as elastomeric films tend to block more as do films with lower molecular weight components as such form temporary bonds that lead to blocking) on film blocking. In a further testing of the control films and breathable elastic films with various skin layers, the films were tested for peel after the film rolls were aged for 24 and 48 hours at 130° F. in an oven. The film without skin and the film with skin of EVA/Catalloy blend could not be peeled off the storage roll to test for peels. However, films with low density polyethylene and skins with low density polyethylene and calcium carbonate blend still exhibited easy peel despite the elevated temperature. The skin with both low density polyethylene and calcium carbonate performed better than that with only the low density polyethylene.

The skin layer with the calcium carbonate on the surface would provide better printability and bond capability as well. The films with skin layers made from either low density polyethylene or the low density polyethylene and calcium carbonate materials did not need to be peeled off the storage rolls. They were unwound without any significant effort.

In connection with the above formulation of elastic breathable films, it was important to utilize skin layers that cracked or otherwise allowed the passage of air (for breathability) following stretching in a machine direction orientor, and which did not unduly hinder the elastic performance of the core layer. Such films typically had a basis weight of about 30-35 gsm. However, with the formulation of nonbreathable films, the focus is was to utilize films that allowed the passage of air/vapor. Instead, the focus was to utilize skin layers that further enhanced the elastic performance of the core layer of the film. In such instances, the films typically were somewhat heavier than the breathable films, and had basis weights of about 40 gsm. Such examples follow.

### EXAMPLES OF NON-BREATHABLE NONBLOCKING ELASTIC FILMS

Various specific film formulations were evaluated to determine blocking attributes using the above tests. The film formulations evaluated included the following:

TABLE 4

| Film | Core % | | Skin % | Skin |
|---|---|---|---|---|
| Code | Volume | Core Composition | Volume | Composition |
| 1 | 100% | 88.2% AFFINITY | 0 | 0 |
| | | EG8200 | | |
| | | 11.8% | | |
| | | diatomaceous earth | | |
| | | and resin (abt: 80% | | |
| | | Dow | | |
| | | AFFINITY EG8185 | | |
| | | and 20% CELITE | | |
| | | 263) | | |
| 2 | 97% | 100% AFFINITY | 3% | 88.2 AFFINITY |
| | | EG8200 | | PT1450 11.8% |
| | | | | diatomaceous earth |
| | | | | and resin (abt. 80% |
| | | | | Dow AFFINITY |
| | | | | EG8185 and 20% |
| | | | | CELITE 263) |
| 3 | 97% | 58.8% AFFINITY; | 3% | 88% AFFINITY |
| | | EG8200 29.4% | | PT1450; 10% (80% |
| | | KRATON G1657; | | Dow AFFINITY |
| | | 11.8% | | EG8185 and 20% |
| | | diatomaceous earth | | CELITE 263) 2% |
| | | and resin (abt. 80% | | (75% CALCIUM |
| | | Dow AFFINITY | | CARBONATE |
| | | EG8185 and 20% | | CONCENTRATE |
| | | CELITE 263) | | IN DOWLEX ™ |
| | | | | 2517 LLDPE) |
| 4 | 97% | 60% AFFINITY | 3% | 88% AFFINITY |
| | | EG8200; 40% | | PT1450; 10% (80% |
| | | CALPRENE C-500 | | Dow AFFINITY |
| | | | | EG8185 and 20% |
| | | | | CELITE 263) 2% |
| | | | | (75% CALCIUM |
| | | | | CARBONATE |
| | | | | CONCENTRATE |
| | | | | IN DOWLEX ™ |
| | | | | 2517 LLDPE) |

For the above polymer components, the AFFINITY EG 8200 demonstrated a melt index of 5. The AFFINITY EG 8185 demonstrated a melt index of 30. The AFFINITY PT 1450 demonstrated a melt index of 7.5. The conditions of film manufacture were as follows. The melt temperatures of the extruders ranged from about 400° F. to about 425° F. The chill roll temperature was about 60° F. The extruder pressures ranged from about 1700 to about 4800 psi.

All of the above codes were cast embossed, except for code 1, that was made on a cast-chill roll. Code 1 demonstrated roll blocking, and increased extruder pressure. The resulting film was tacky. Code 2 demonstrated a tacky film but was capable of being unwound. Codes 3 and 4 were fairly elastic and demonstrated freedom to unwind. The elastomeric properties and other performance of the various film codes are shown in the following Table 5. The values have been rounded to the single “ones” place. The percentage shown for the skin layer is the total percentage, with each of two skin layers (on opposite sides of the core) being half of the stated volume (above). In Table 5 below, the data across the table from Stress Elong. at 50% through the Elong. at break, were determined using the (Tensile) Stress Elongation test described above, while the data under Hysteresis was gathered using the Equilibrium Hysteresis Test above. All other tests were done on the Tension Set test described above (load at 25, 50 and 100%). All tests were done on the CD direction of the material.

TABLE 5

| | Stress Elong. | Load at | Peak | Elong. At | Load @ | | Load @ | |
|---|---|---|---|---|---|---|---|---|
| | at 50% | Interc. | Load | break | 25% | Load @ | 100% | % Hyst. |
| Code | (g) | (g) | (g) | (%) | (g) | 50% (g) | (g) | 1 cycle |
| 2 | 220 | 372 | 807 | 927 | 60 | 96 | 107 | 44 |
| 3 | 435 | 764 | 1890 | 994 | 110 | 192 | 223 | 39 |
| 4 | 251 | 381 | 944 | 959 | 69 | 105 | 113 | 46 |

Code 1 was not measured due to roll blocking. Stress-elongation testing and equilibrium hysteresis was done at a 1 inch wide sample. Tension set was done with a dog-bone shaped material as noted. The basis weights of the films were about 40 gsm. Tack testing was then run on code 4 above in accordance with the above Tack test method. The film tack test was run about 12 months following production under ambient conditions. After 6 repetitions of samples, the average resulting tack of the code was 1.05 g. (approximately ambient conditions). The above table demonstrates the differences in elastic performance for each of the various materials utilized above. Depending on the product application desired, a range of elastic attributes are available with skin layers, which films will assist in allowing for further lamination to additional sheet materials and which will prevent blocking, should the film be stored for later use. In one embodiment, the nonbreathable elastic film demonstrates a load at 50 percent of between about 50 and 300 gf. In another embodiment, such film demonstrates a load at 50 percent of greater than about 95 gf.

From the data of the various embodiments, it can be seen that elastic films that are either breathable or nonbreathable are now provided that can be stored in roll form prior to use, without risk of roll blocking. For example, in one embodiment, an elastic multilayered film with tack of less than about 20 grams is provided. In an alternative embodiment, such a film is provided with a tack of less than about 15 grams. In still another embodiment, such a film is provided with a tack of less than about 5 grams. In one embodiment, such film is a multilayered film with at least one skin layer. In a second embodiment, such film is a multilayered film with at least two skin layers, with the skin layers sandwiching a core layer. In still another embodiment, such film layer is bonded to a facing layer on at least one side, such as a necked spunbond or a bonded carded web.

While the invention has been described in detail with reference to specific embodiments thereof, it should be understood that many modifications, additions and deletions can be made thereto without departure from the spirit and scope of the invention as set forth in the following claims.

What is claimed is:

1. A nonblocking elastic film which demonstrates a tack level upon being unwound from a storage roll of less than about 20 g.

2. The nonblocking elastic film of claim 1 wherein said film demonstrates a tack level upon being unwound from a storage roll of less than about 15 g.

3. The nonblocking elastic film of claim 1 wherein said film demonstrates a tack level of less than about 5 g.

4. The nonblocking elastic film of claim 1 comprising a multilayered film including at least one skin layer and a core layer.

5. The nonblocking elastic film of claim 4, wherein said multilayered film is breathable.

6. The nonblocking elastic film of claim 4, wherein said multilayered film includes a core layer and at least one skin layer, and further wherein said core layer volume is between about 80 and 98 percent, and said skin layer(s) volume is between about 2 and 20 percent.

7. The nonblocking elastic film of claim 5, wherein said film demonstrates a WVTR of greater than about 100 g/m²/24 hours.

8. The nonblocking elastic film of claim 5, wherein said at least one skin layer comprises a polyethylene having a density of between about 0.915 and 0.923 g/cc.

9. The nonblocking elastic film of claim 6, wherein said at least one skin layer further comprises filler.

10. The nonblocking elastic film of claim 9, wherein said filler comprises between about 5 and 50 weight percent of the skin layer.

11. The nonblocking elastic film of claim 5, wherein said skin layer(s) comprise between about 1 and 4 volume percent of the film, and said core layer comprises between about 96 and 99 volume percent of said film.

12. The nonblocking elastic film of claim 5, wherein said core layer comprises a blended thermoplastic elastomer and a filled semi-crystalline predominantly linear polymer, said core layer comprising between about 25 and 70 weight percent filler, between about 5 and 30 by weight percent semi-crystalline linear polymer, and between about 15 and 60 by weight elastomeric polymer, wherein said filler is closely associated with said semi crystalline linear polymer, and wherein said at least one skin layer comprises a low density polyethylene, and a filler.

13. The nonblocking elastic film of claim 4, wherein said film is nonbreathable, and further, wherein said core layer is comprised of a polyolefin based elastomer.

14. The nonblocking elastic film of claim 13, wherein said skin layer is comprised of between about 75 and 100 percent polyolefin based elastomeric material, and between about 0 and 25 percent of a compound with at least 5 percent of an antiblock agent.

15. The nonblocking elastic film of claim 14, wherein said core layer comprises between about 95 and 97 percent of the volume of the film.

16. The nonblocking elastic film of claim 13, wherein said core layer is a blend of between about 50/50 to 80/20 of a polyolefin based elastomer and a styrene block copolymer.

17. A nonblocking, breathable, multilayered elastic film comprising a core layer and at least one skin layer, wherein said core layer comprises a blended thermoplastic elastomer and a filled semi-crystalline predominantly linear polymer, such that said core layer comprises between about 25 and 70 weight percent filler, between about 5 and 30 by weight percent semi-crystalline linear polymer, and between about 15 and 60 by weight elastomeric polymer, wherein said filler is closely associated with said semi crystalline linear polymer, and wherein said skin layer comprises a low density polyethylene having a density between about 0.915 and 0.923 g/cc, and a filler in a percentage of said skin layer of between about 5 and 50 weight percent.

18. A nonblocking, nonbreathable multilayered elastic film comprised of a core layer and at least one skin layer, wherein said core layer is comprised of a polyolefin based elastomer, said skin layer is comprised of between about 75 and 100 percent polyolefin based elastomeric material, and between about 0 and 25 percent of a compound having at least 5 percent of an antiblock agent.

19. The nonblocking, nonbreathable multilayered elastic film of claim 18 wherein said compound is between about 8 and 15 percent of said skin layer.

20. The nonblocking, nonbreathable multilayered elastic film of claim 19, wherein said antiblock agent is between about 10 and 25 percent of the compound.

21. A personal care article comprising the elastic breathable film of claim 17.

22. An outercover of a personal care article comprising the film of claim 17.

23. A personal care article comprising the elastic nonbreathable film of claim 18.

24. An ear attachment of a personal care article comprising the film of claim 18.

25. A method for producing a multilayered elastic film with reduced roll blocking comprising:
coextruding a core layer and at least two skin layers on opposing surfaces of the core layer; wherein said core layer comprises a blended thermoplastic elastomer and a filled semi-crystalline predominantly linear polymer, such that said core layer comprises between about 25 and 70 weight percent filler, between about 5 and 30 by weight percent semi-crystalline linear polymer, and between about 15 and 60 by weight elastomeric polymer, wherein said filler is closely associated with said semicrystalline linear polymer,
and wherein said skin layers comprise a low density polyethylene having a density between about 0.915 and 0.923 g/cc, and a filler in a percentage of said skin layers of between about 5 and 50 weight percent;
stretching said coextruded film in at least one direction;
annealing said coextruded film; and
allowing said coextruded film to retract between about 15 and 25 percent.

26. The method of claim 25, further including the step of laminating a nonwoven layer to at least one side of said retracted coextruded film.

27. A method for producing a multilayered elastic film with reduced roll blocking comprising:
coextruding a core layer and at least one skin layer, wherein said core layer is comprised of a polyolefin based elastomer, and said skin layer is comprised of between about 75 and 100 percent polyolefin based elastomeric material, and a compound having at least 5 percent of an antiblock agent.

28. The method of claim 27, further including the step of laminating a nonwoven layer to at least one side of said coextruded film.

29. The method of claim 27, wherein said produced film demonstrates a load at 50 percent of between about 50 and 300 gf.

30. The method of claim 27, wherein said produced film demonstrates a load at 50 percent of at least 95 gf.

31. A storage roll with elastomeric film stored thereupon, said roll demonstrating a tack level of less than 20 g upon said film being unwound from said roll.
